(19) United States
(12) Patent Application Publication
(10) Pub. No.: US 2024/0084561 A1
(43) Pub. Date: Mar. 14, 2024

(54) SYSTEMS AND METHODS FOR WATER DISTRIBUTION NETWORK LEAKAGE DETECTION AND/OR LOCALIZATION

(71) Applicant: CASE WESTERN RESERVE UNIVERSITY, Cleveland, OH (US)

(72) Inventors: Xiong Yu, Beachwood, OH (US); Xudong Fan, Cleveland, OH (US)

(21) Appl. No.: 18/456,958

(22) Filed: Aug. 28, 2023

Related U.S. Application Data
(60) Provisional application No. 63/401,643, filed on Aug. 27, 2022.

(51) Int. Cl. E03B 7/00; G06N 3/0455; G06N 3/0464; G06N 3/088

(52) U.S. Cl. CPC E03B 7/003; G06N 3/0455; G06N 3/0464; G06N 3/088

(57) ABSTRACT

In a described example, a system for leak detection and localization is provided. The system includes a water distribution network (WDN) partition stage programmed to cluster a WDN model into partition zones based on applying a modified k-means clustering algorithm to leakage characteristic data and physical connectivity data. A leakage monitoring stage can be programmed to detect the occurrence of leakage in the WDN and provide leak detection data based on applying a trained unsupervised leakage detection machine-learning model to the partition zones and sensor data. The leakage monitoring stage can also provide localization data to identify a location of a leakage zone in the WDN based on feeding the leak detection data to a localization machine-learning model.

### RELATED APPLICATION

This application claims priority from U.S. Provisional Application No. 63/401,643, filed Aug. 27, 2022, the subject matter of which is incorporated herein by reference in its entirety.

### GOVERNMENT FUNDING

This invention was made with government support under 1638320 by the National Science Foundation. The government has certain rights in the invention.

### TECHNICAL FIELD

This application relates to systems and methods for water distribution network leakage detection and/or localization.

### BACKGROUND

Fast detection and localization of underground water pipe leakage is an important yet challenging issue in water distribution system management. Due to the deterioration of underground water pipes, a large amount of water is lost every year, mostly unnoticed. According to Sadeghioon, about 3,281 megaliters (10⁶) was wasted in the UK during 2009-2011, and about 15% of supplied water was wasted annually in the US. In historical water districts, such as Cleveland, OH, or Boston, MA, the percentage of water lost is significantly higher. Moreover, unnoticed water leakage can lead to serious social impacts due to traffic delay, water contamination, and water scarcity. Therefore, a system that provides real-time water pipe monitoring and enables fast leakage response is critical for agencies to institute preventative strategies with significant socio-economic benefits.

A significant number of studies has been conducted on water pipe leak detection. The strategies are broadly classified into 5 categories, i.e., visual observation-based, sensor/instrumentation based, transient response based, hydraulic model-based, and data-driven based strategies. However, these strategies have encountered different limitations. For instance, the conventional sensor/instrumentation-based technologies require well-trained inspectors to conduct the inspection along the pipes with the help of different types of detection equipment including those based on the optical, acoustic, or electromagnetic sensing principles. This method can be labor-intensive, time-consuming, and cost-prohibitive. Moreover, the reliability of detection are influenced by various factors including the type of leakage, size of the leakage, pipe materials, environmental conditions, and the skill level of the inspector. The transient based technology uses transient pressure or acoustic signals associated with burst events. Such transient signals travel along the pipe at the speed of sound starting from the burst location. However, the transient responses decay with distance and diminish over a short time, and therefore require sensors with high spatial and temporal resolutions, which makes it not suitable for continuous monitoring in all environments. The hydraulic model-based approach requires the use of the hydraulic model simulation of the water distribution network (WDN). But information such as customer water usage, pipe deterioration conditions, pipe physical information is often difficult to collect or is typically not available. Data driven-based leak detection, which is based on learning from historical data with statistical or pattern recognition algorithms, is emerging. Such technologies mainly depend on the available historical dataset without the requirement of collecting a comprehensive set of information of the hydraulic model. Empowered with the Internet of Things (IoT) and artificial intelligence (AI), data-driven technologies have been proven capability in knowledge discovery, image processing, and event forecasting, etc. The development of supervisory control and data acquisition (SCADA) systems also promotes the progress in using data-driven methods for leakage detection since real-time monitoring data of water pressure and/or flow rate are available via SCADA system.

A few data-driven methods have been developed to detect leakage in the WDNs. The previous studies typically formulate the leakage detection problem as either a supervised machine learning (ML) problem or an unsupervised ML problem. For instance, a supervised ML method has been developed by using fully connected DensNet for leakage detection. The sensors were firstly assumed to be placed at different junctions determined by an optimization process. The simulated water pressure data obtained by these sensors was used to train the developed ML model and achieved promising results. For another example, the data collected by piezoelectric accelerometer under non-leaking condition and under leaking condition. The labelled data was trained by a Convolutional Neural Network (CNN) and a Support Vector Machine (SVM) to class leaking versus non-leaking conditions. Although supervised learning approach can achieve a high leakage localization accuracy, it requires a balanced dataset, which means it needs a sufficient amount of WDN operational data under both leaking conditions and nonleaking conditions. However, datasets under leaking conditions are very scarce. Consequently, unsupervised ML model are more feasible practically. For example, Artificial Neural Network can be used to predict the water flow and water pressure one day ahead. Leakage warning was triggered if the difference between the actual data and the predicted data exceeds a threshold. However, the detection accuracy was dependent upon a stable water pressure pattern in the WDN, which however can be significantly affected by water usage behaviors. The developed methods have only been used for leakage detection and not attempted for leakage localization.

### SUMMARY

This description introduces the development of a novel machine learning (ML) model to detect the occurrence of underground leakage and localize where leaks occur. This new framework, named clustering-then localization semi-supervised learning (CtL-SSL), uses the topological relationship of WDN and its leakage characteristics for WDN partition and sensors placement, and subsequently utilizes the monitoring data for leakage detection and leakage localization.

This method deals with the unique feature of leak detection, where in-service WDNs are short of labeled data under leaking conditions, which makes it infeasible to use common ML models. The developed CtL-SSL framework advances the leak detection strategy by alleviating the data requirements, guiding optimal sensor placement, and locating leakage via WDN leakage zone partition. It features excellent scalability, extensibility, and upgradeability for applications to various types of WDNs. It will provide valuable a tool in sustainable management of the WDNs.

This description also describes the development of a novel machine learning (ML) models to assist the best decisions to achieve the most resilient system recovery. The model integrates Graph Convolutional Neural Network and Deep Reinforcement Learning (GCN-DRL) model to support optimal repair decisions after the water supply system is subjected to natural hazards. Such decisions will improve WDN resilience after natural hazards such as earthquakes etc.

The framework includes a framework for evaluation of the resilience of a WDN, which can be used together with different definitions of the WDN performance. The resilience indicator integrates the dynamic evolution of WDN performance indicators during the post-hazard (earthquake) recovery process. The decision goal is set that the performance indicator for WDN with consideration of the relative importance of the service nodes and the extent of post-hazard water needs that are satisfied.

For example, the GCN of the GCN-DRL model framework is configured to encode the information of the WDN. The topology and performance of service nodes (i.e., the degree of water needs satisfaction) can be considered as inputs to the GCN; the outputs of GCN are the reward values (Q-values) corresponding to each repair action, which are fed into. Also, or as an alternative, the DRL process of the GCN-DRL model framework is configured to select the optimal repair sequence from a large action space.

The decision support model aimed achieve highest system resilience by ensuring the fastest system recovery. This ensures the best decision and resource allocations. The framework can also be used for other types of infrastructure networks.

### BRIEF DESCRIPTION OF THE DRAWINGS

FIG. 1 illustrates a flowchart of a proposed cluster-then-localization semi-supervised learning (CtL-SSL) algorithm for WDN leak detection and localization.

FIG. 2 illustrates PCA-based leakage characteristics matrix.

FIG. 3 illustrates AE and AE based leakage characteristics matrix.

FIGS. 4A and 4B illustrates the ML models for leakage detection and localization, in FIG. 4A shows example procedures for training ML models, and FIG. 4B shows example procedures for model applications in leakage detection and localization.

FIG. 5 illustrates a topology of C-Town water distribution network.

FIG. 6 illustrates example of water head fluctuation under normal or leaking conditions at Junction 370.

FIG. 7 illustrates results of WDN leakage zone partition with five different approaches.

FIGS. 8A and 8B illustrate reconstruction error of non-leaking vs leaking samples, in which FIG. 8A shows error detected by an AE detector, and FIG. 8B shows error detected by a PCA detector.

FIG. 9 illustrates leakage detection accuracy with two different unsupervised ML models under different number of partitions (k value).

FIG. 10 illustrates accuracy of leakage zone localization using different WDN partitioning strategies.

FIGS. 11A and 11B illustrate leakage localization accuracy with an RF model.

FIGS. 12A and 12B illustrate comparison the influence of sensor placements on the performance of the developed CtL-SSL framework.

FIG. 13 is a graph showing the influence of weights assigned to the leakage characteristics distance during WDN clustering (stage 1) on the final leakage localization accuracy (stage 2).

FIGS. 14A, 14B, 14C and 14D illustrate WDN partition results based on different weights assigned to the leakage characteristics.

FIG. 15 illustrates WDN graph structural of Rancho Solano Zone III (Red node denotes junction ‘J1131’).

FIG. 16 illustrates example of water head fluctuation under normal or leaking conditions at Junction ‘1131’.

FIGS. 17A, 17B and 17C illustrate WDN leakage zone partition results when considering different values of k.

FIG. 18 is a graph showing final leakage detection and localization accuracy.

FIG. 19 illustrates an example of WDN system performance prior, during, and after disruption by hazards, the characteristics of which define system resilience.

FIG. 20 illustrates of framework of the system resilience assessment and recovery.

FIG. 21 illustrates of an example process of reinforcement learning.

FIG. 22 illustrates concept of DRL that use Artificial Neural Network (ANN) as the deep Q function.

FIG. 23 illustrates an example architecture of GCN-DRL Hybrid ML model.

FIG. 24 illustrates the testbed WDN of Fairfield, California, with annotation of node importance and ground soil types.

FIGS. 25A and 25B illustrate distribution of PGV along the pipelines and distribution of damaged pipes with the number of damages indicated.

FIG. 26 illustrates the learning curve according to the methods described herein.

FIG. 27 illustrates an example of crossover for a genetic-based algorithm method.

FIG. 28 illustrates trajectories of WDN recovery using repair sequences by different decision methods.

FIGS. 29A, 29B and 29C illustrate example failure scenarios as a subset of original failure pipes.

FIG. 30 illustrates an overview of an intelligent system monitoring application.

FIG. 31 illustrates an example welcome page of the intelligent leak detection application.

FIG. 32 illustrates an example interface of hydraulic simulation.

FIG. 33 illustrates an example interface for determination of the optimal sensor placement and clusters.

FIG. 34 illustrates an example interface to manage and display of data by water pressure monitoring sensor.

FIG. 35 is a schematic of an example architecture of an autoencoder neural network that can be used in the systems and methods described herein.

FIGS. 36A and 36B illustrate graphs showing leakage localization accuracy with an RF model.

FIG. 37 is a plot showing sensitivity of leak detection accuracy over the leak size and the compression ratio of AE neural network model.

FIG. 38 is a graph showing leak size distribution of a water system.

FIG. 39 is a schematic diagram showing an overview of system functions for leak detection and localization.

FIG. 40 illustrates an example user interface.

FIG. 41 illustrates another example user interface for cluster and sensor optimization, and data query.

FIG. 42 are graphs showing the results of accuracy using AI-based leak detection and localization according to systems and methods described herein.

### DETAILED DESCRIPTION

This description introduces the development of a novel machine learning (ML) model to detect the occurrence of underground leakage and localize where leaks occur. This new framework, named clustering-then localization semi-supervised learning (CtL-SSL), uses the topological relationship of WDN and its leakage characteristics for WDN partition and sensors placement, and subsequently utilizes the monitoring data for leakage detection and leakage localization.

This novel method deals with the unique feature of leak detection, where in-service WDNs are short of labeled data under leaking conditions, which makes it infeasible to use common ML models. The developed CtL-SSL framework advances the leak detection strategy by alleviating the data requirements, guiding optimal sensor placement, and locating leakage via WDN leakage zone partition. It features excellent scalability, extensibility, and upgradeability for applications to various types of WDNs. It will provide valuable a tool in sustainable management of the WDNs.

This description introduces the development of a novel machine learning (ML) models to assist the best decisions to achieve the most resilient system recovery. The model integrates Graph Convolutional Neural Network and Deep Reinforcement Learning (GCN-DRL) model to support optimal repair decisions after the water supply system is subjected to natural hazards. Such decisions will improve WDN resilience after natural hazards such as earthquakes etc.

The framework includes a framework for evaluation of the resilience of a WDN, which can be used together with different definitions of the WDN performance. The resilience indicator integrates the dynamic evolution of WDN performance indicators during the post-hazard (earthquake) recovery process. The decision goal is set that the performance indicator for WDN with consideration of the relative importance of the service nodes and the extent of post-hazard water needs that are satisfied.

The novel GCN-DRL model framework, where, the GCN encodes the information of the WDN. The topology and performance of service nodes (i.e., the degree of water needs satisfaction) can be considered as inputs to the GCN; the outputs of GCN are the reward values (Q-values) corresponding to each repair action, which are fed into the DRL process to select the optimal repair sequence from a large action space.

The decision support model aimed achieve highest system resilience by ensuring the fastest system recovery. This ensures the best decision and resource allocations. The framework can also be used for other types of infrastructure networks.

To further advance the data-driven approach for leakage detection and localization in water distribution network, this description explores a new ML framework that combines the advantages of both supervised ML and unsupervised ML approaches. This new framework, named clustering-then-localization semi-supervised learning (CtL-SSL), uses the topological relationship of WDN and its leakage characteristics for WDN partition, sensors placement, and subsequently utilize the monitoring data for leakage detection and leakage localization. Compared with previous studies, this framework, 1) considers the spatial relationship of the sensors in WDN portioning and sensor placement, such relationship is the cornerstone for later leakage detection and localization; 2) does not require any historical leakage data for leakage detection; 3) can be used when only limited historical leakage data is available. More specifically, the leakage detection uses unsupervised learning algorithm to compress and decompress the normal water pressure data. This process performs poorly when the input is leakage data. The leakage localization uses supervised learning algorithm to extract the spatial relationship from the available leakage data. Only limited leakage data is required for each leakage zone with the help of proposed WDN partition process.

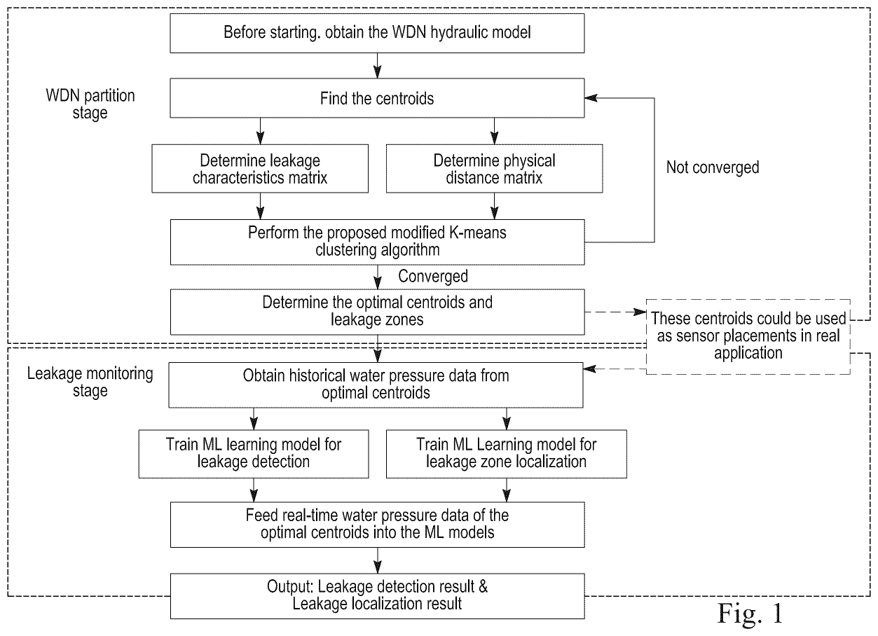

FIG. 1 illustrates an example developed CtL-SSL framework for WDN leak detection and localization. The framework starts with a basic hydraulic model of the WDN to generate the simulated operational data with consideration of the structural, physical, topological, hydraulic characteristics of the WDN as well as the characteristics of water user demands. It includes two stages, i.e., the WDN partition stage and leakage monitoring stage. In the WDN partition stage, the WDN is partitioned into k leakage zones by using a modified k-means clustering algorithm that considers the junctions' leakage characteristics matrix (a matrix that describes the leakage behaviors of each junction, details are given in the section entitled Determination of the leakage characteristics matrix) and the physical locations. The centroid of partitioned clusters also provides the optimal locations of sensor placement. In the leakage monitoring stage, a ML model was trained with nonleaking data to determine the leakage that occurs in the WDN, and another ML model was trained with available labeled leakage data to locate the exact leakage occurrence zone. Components involved in the implementation of the workflow in FIG. 1 are introduced below.

### Determination of the Leakage Characteristics Matrix

In previous studies, the leakage characteristic vector is simply determined by using the difference of pressure at monitored junctions before and after leakage at a given junction. Hence, the length of the vector equals to the number of sensors m. A novel leakage characteristic matrix was proposed in this study by using the PCA and AE algorithm to find the spatial relationship among the sensors, which extract the first k principal components, with k equals to m/2. The conventional leakage matrix is then projected to the k principal components. The resultant leakage characteristics vector achieved dimension reduction from m to k (or by half since k is set to be m/2). The leakage characteristic matrix are subsequently used for clustering of the WDN. Details about the conventional leakage characteristic matrix and proposed leakage characteristic matrix are given below.

### Conventional Leakage Characteristics Matrix

Zhang and Chen defined the leakage characteristics matrix using the change of monitored water pressure due to a given leakage occurring at each junction compared with non-leaking conditions. Table 1 illustrates the calculation of the leakage characteristics matrix, where each row is the leakage characteristics vector corresponding to the junction.

TABLE 1
Leakage characteristics matrix, pᵢ^{j}, based on water pressure change for a WDN with
n junctions and m monitoring sensors (i is the sensor No., j is the junction No.)

| pressure change | Pressure sensor 1 | Pressure sensor 2 | . . . | Pressure sensor m |
|---|---|---|---|---|
| junction 1 | p₁^{nonleak} − p₁^{jun1} | p₂^{nonleak} − p₂^{jun1} | . . . | pₘ^{nonleak} − pₘ^{jun1} |
| junction 2 | p₁^{nonleak} − p₁^{jun2} | p₂^{nonleak} − p₂^{jun2} | . . . | pₘ^{nonleak} − pₘ^{jun2} |
| . . . | . . . | . . . | . . . | . . . |
| junction n | p₁^{nonleak} − p₁^{jun n} | p₂^{nonleak} − p₂^{jun n} | | pₘ^{nonleak} − pₘ^{jun n} |

where pᵢ^{nonleak} is the water pressure measured by sensor i under non-leaking conditions. pᵢ^{jun j} is the water pressure of sensor i when leaking occurs at junction j. i is the index for sensors which ranges from 1 to m, j is the index for junctions, which ranges from 1 to n.

The leakage characteristics matrix defined in Table 1 does not consider the internal relationships among the monitoring sensors. Previous studies have proven that such internal relationship is sensitive to leakage occurrence and therefore can be used for leakage detection and localization. Hereby, to further extract the underlying relationships between the junctions, this study proposed two new leakage characteristics extracted by unsupervised learning algorithms, i.e., the Principal Component Analysis (PCA) and Autoencoder neural network (AE). Details of the PCA-based and AE-based leakage characteristics matrix are described in the following.

### PCA-Based Leakage Characteristics Matrix

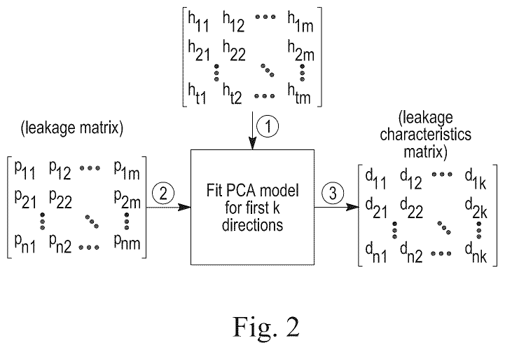

PCA is an unsupervised ML model that is often used for the dimensional reduction of data samples. An example process to calculate PCA-based leakage characteristics is illustrated in FIG. 2. In the example of FIG. 2 h is the training dataset that consists of non-leaking dataset, p is the leakage matrix containing vectors of the monitored water pressure when leakage happens at each junction, d is the PCA-based leakage characteristics matrix, m is the number of monitoring sensors, t is the number of samples for training PCA model, n is the number of junctions, k equals m/2. It is assumed m monitoring sensors are installed in the WDN for data collection. A non-leaking dataset contains t samples, each includes a vector of data by m monitoring sensors, is first used to train the PCA model to obtain the first k principal directions (Step 1 in FIG. 2). There is no requirement for the number of training samples. However, the more the samples, the better the PCA model in finding the relationships among the monitoring sensors. Then, the leakage matrix [pᵢⱼ] is transformed by using the PCA model (Step 2 in FIG. 2). The leakage matrix, [pᵢⱼ], here is defined as a matrix consisting of the monitored water pressure vector at the m monitoring sensors when a leakage happens to each of the n junctions in turn. That is, the i^{th} row of the leakage matrix is a vector consisting of the water pressure by the m sensors when the leak occurs at the i^{th} junction. By feeding the leakage matrix, [pᵢⱼ], to the trained PCA model, the output matrix [a] is named as the PCA-based leakage characteristics matrix (Step 3 in FIG. 2).

Due to dimension reduction by the PCA, for each of the n junctions, its leakage characteristics are represented by a projected vector with k elements. The dimension of principal components k is set to be around m/2, as this study found this well captures the relationship among the monitored junctions.

### AE-based Leakage Characteristics Matrix

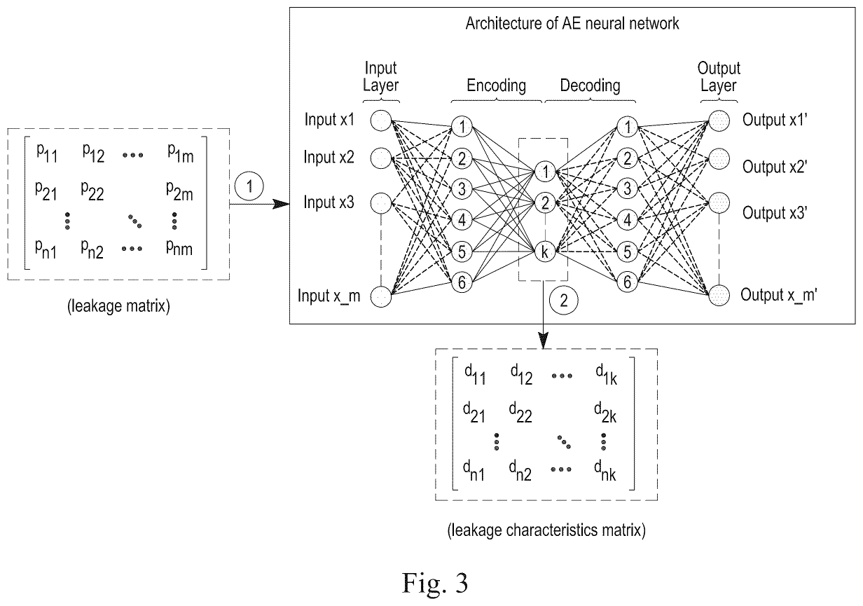

AE neural network is an unsupervised learning algorithm based on deep neural network. Unlike the PCA method, which is an orthogonal linear transformation, AE neural network can extract non-linear relationships among data samples. An example architecture of AE network that can be used to implement the systems and method described herein is shown in FIG. 3. In FIG. 3, p, d, m, n, k represent the same parameters as in FIG. 2. For each sample with m features, the AE network encodes the original dataset into a compressed dimensional space and then decode it to the original dimension. By minimizing the difference between output and input, the neural network is forced to learn the features of the samples and their relationships.

AE-based leakage characteristics matrix is defined as illustrated in FIG. 3. Firstly, an AE neural network is built with a middle layer consisting of k neurons (FIG. 3). The AE model is pre-trained with the monitoring dataset from the WDN under non-leaking situations (this step is not shown in FIG. 3). This pre-trained AE neural network learned the internal relationship among the monitored junctions under non-leaking conditions. Then, the leakage matrix (which is the same as the PCA process) is fed into the AE neural network (FIG. 3 Step 1). The output of the middle layer of the AE neural network consists of the leakage characteristics vector corresponding to each junction. Matrix [d], which is dimension reduced from m to k compared with leakage matrix [pᵢⱼ] is defined as the AE-based leakage characteristics matrix. Similar to the PCA-based leakage characteristics matrix, the reduced dimension k is set as m/2.

Both the PCA- and AE-based leakage characteristics matrix are derived from the projected leaking data matrix by PCA or AE models which are pre-trained with non-leaking dataset only. This process effectively utilized these ML models for the feature extraction. Meanwhile, as a byproduct of the feature extraction process, the utilized characteristics matrix is only half-the-size of the monitored data size and conventional leakage characteristics matrix. Such data size reduction could potentially increase the computing and data storing efficiency as more data are collected by the sensors.

### WDN Partition Stage: Modified k-Means Clustering Algorithm

K-means clustering algorithm clusters data based on their Euclidian distance. The standard k-means algorithm has been used in previous studies for the WDN zone partition to reduce the degree of freedoms in leakage detection, based on the conventional leakage characteristics matrix. The partition aims to improve leakage detection and localization accuracy.

This existing WDN partition procedure has a few limitations. Firstly, the standard k-means algorithm requires the number of sensors and their placements to be predefined. For example, the monitoring data collection schema is set in advance and the standard algorithm cannot consider the influence of choosing different sensor placements during the clustering process. For example, Zhang used Zheng's algorithm to optimize sensor placements before initializing the WDN partitioning via the k-means clustering process. Secondly, the previous WDN partitioning (i.e.,) only considered the leakage characteristics. It did not consider the physical distance among the monitoring junctions. The consequence is the junctions clustered into the same WDN zone can be geographically scattered on the WDN.

To overcome these limitations, a modified k-means clustering algorithm is developed in this study for WDN partition. Compared to the standard k-means WDN clustering which only considers the leakage characteristics of junctions, the new algorithm also considers the shortest physical path distance between the junctions over the WDN. The pseudocode of the proposed k-means algorithm is shown in the following Table 2.

TABLE 2
Modified k-means cluster algorithm for WDN partition

Algorithm: Modified k-means algorithm for WDN leakage zone partition
step 1: Initialize parameters: set the number of cluster k, tolerance,
maximum iteration number
step 2: Randomly select k junctions from the WDN as the first group of
centroids.
step 3: Data preparation
step 3.1: Prepare the leakage characteristics matrix.

| | |
|---|---|
| • | I.a) For the conventional leakage characteristics matrix, use |
| | Table 1. |
| • | I.b) For PCA- or AE- based leakage characteristics matrix, |
| | follow Figs 2 and 3 respectively. |
| • | II. Normalize the leakage characteristics matrix by dividing its |
| | maximum value. |

```
  step 3.2: Calculate the WDN physical pair distance matrix by
  computing the shortest path between all junctions. Standardize the
  matrix by dividing its maximum value.
step 4: Calculate the total Euclid distance between junctions
  step 4.1: Calculate the junctions' Euclid distance matrix measured by
  the junction leakage characteristics matrix pairs, L_{leakage}
  step 4.2: Calculate the component of Euclid distance matrix measured
  by the physical distance between junctions, L_{physical}.
step 5: Assign each junction (v ∈ J) to its nearest clusters based on the
total Euclid distance defined as
          L_{v,c}_{ᵢ}= (L_{(v,c}_{ᵢ}₎^{leakage} + L_{(v,c}_{ᵢ}₎^{physical})/2.
      v ∈ clusterᵢ, if L_{v,c}_{ᵢ}≤ L_{v,c}_{ᵢ}, ∀l ∈ {1,2,3, ... , k)
  where J is the set of all junctions, L_{v,ci} is the represent distance between
        junction i and centroid cᵢ, cᵢ is the centroid of cluster i,
step 6: Centroids redistribution
  step 6.1: For clusterᵢ, set junction vₖ as the new centroid. Replace the
  original centroid cᵢ and determine the new group of centroids (vₖ, c₂,
  c₃, ... , cₖ)
  step 6.2: Recalculate the leakage characteristics matrix in step 3.1 with
  the new group of centroids.
  step 6.3: Recalculate the distance from to vₖ all other junctions in
  clusterᵢ.
  step 6.4: For every junction in clusterᵢ, repeat step 6.1 to 6.3 to find the
  junction with the minimum total distance as the new centroid for
  clusterᵢ, i.e.,
        cᵢ^{new} = vₖ, if Σₘ₌₁^{M} Lᵥ_{ₖ}_{,v}_{ₘ} is minimum.
  where cᵢ^{new} is the new centroid for cluster i, M is all junctions in cluster
  i.
  step 6.5: Repeat step 6.1 to 6.4 for all clusters. Until the centroid
  distribution is stabilized.
step 7: Determine the sum of the distance of all clusters to their
  corresponding centroid from step 6. Repeat from step 3 to step 7 until
  the following relationship is satisfied.
      abs(sum(L_{v,c}_{^{new}}) − sum(lL_{v,c})) < tolerance
        or (iteration > number of iteration)
where l_{v,c} is the distance of each junction to its corresponding centroid, c
is the old set of centroids, c^{new} is the new set of centroids.
```

It is noted that in Step 3.1, the leakage characteristics matrix can be obtained by using different definitions, i.e., conventional leakage characteristic matrix based on pressure change or feature extraction with ML algorithms Although PCA and AE models are used in this study, other ML models can also be integrated into this framework, such as the Mahalanobis classification system (MCS). In Step 3.2, the physical distance between pairs of junctions is obtained by using Dijkstra's shortest pathfinding algorithm. Other shortest path algorithms could also be considered when dealing with different types of graphs, such as Floyd-Warshall algorithm. This step guarantees the clustered junctions are concentrated based on their network path distance. Both of the pair distance matrices are normalized by dividing their largest value. Therefore, the range of these distances is from 0 to 1. In Step 5, the represent distance between junctions is defined as the unweighted average of physical distance and leakage characteristics distance. The different ratios between the weight of leakage characteristics distance and physical distance will be discussed below. In Step 6, the process of centroid redistribution of each cluster requires the re-acquire of the leakage characteristics matrix with the new set of centroids. Also, in Step 6, unlike the standard k-means which used the mean value of each cluster as its centroids, the optimal junctions (that minimize distance within the cluster) is set as the new centroids so that centroids remain on the junctions in the WDN. The sensors are recommended to be placed at the centroid to maximize the value of data acquisition. Therefore, the influence of sensor placement is also considered during the WDN partition process.

### Leakage Monitoring Stage: Leakage Detection and Leakage Zone Localization

The WDN partition stage clusters the WDN into partition zones based on leakage characteristics and physical connectivity. The monitoring sensors are recommended to be installed at the centroids of the partition zones to achieve the best value of monitoring data. With the partition zones and sensor data, Stage 2 implements algorithms for leakage detection and localization using the sensor monitoring data.

### Leakage Detection

Two unsupervised ML models, PCA and AE models, are used for leakage detection. Both PCA and AE models are capable of extracting the most important features from the training dataset. Testing data are projected or decomposed into the dimension-reduced feature space; and from the projected components, the original data can be reconstructed with small errors. However, abnormal data that carries unknown features will lead to large reconstruction errors from the pre-trained ML models. This allows abnormal events such as leakages to be detected. The advantage of the proposed models is that they can be trained with unbalanced data (normal non-leaking data in the case of WDN) to detect abnormal conditions.

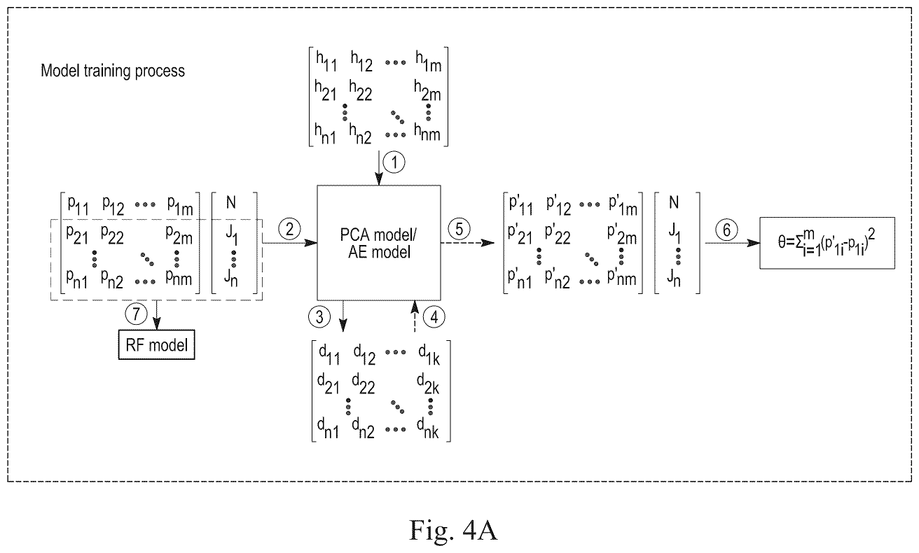

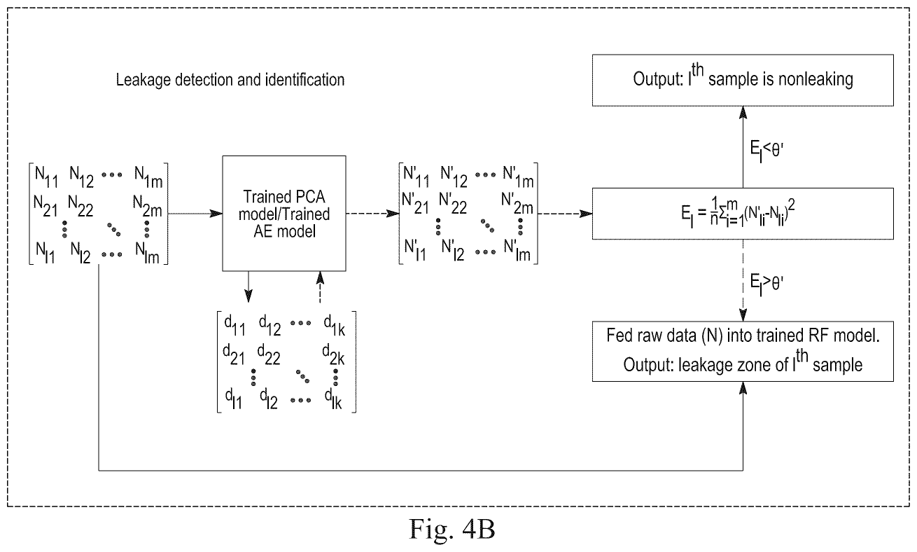

The ML model training process for leakage detection is illustrated in part of FIG. 4a). Firstly, the unsupervised ML model is trained with a dataset under normal non-leaking conditions, as shown in step 1. In the testing stage, the dataset which contains non-leaking data (labeled by N) and limited number of labeled leaking data (labeled by jᵢ) is fed into the trained ML model (step 2). Using the reconstruction capability of the unsupervised ML model (step 3 and step 4), the input data is reconstructed (Step 5). A reconstruction error θ for each sample is computed based on distance measure θ=∥p′−p ∥. Since the ML model is trained with non-leaking dataset only, among the testing dataset, nonleaking samples will have a small reconstruction error while leaking samples will have a larger reconstruction error. A threshold of reconstruction error can be used to differentiate leaking versus non-leaking dataset. This threshold can be obtained by only using nonleaking samples based on the characteristics of reconstruction errors, or further fine-tuned by labeled leaking samples.

### Leakage Localization

The leakage localization is defined as a classification problem, i.e., the leakage conditions are classified into different WDN partition zones. There are various types of ML models for classification problems, such as the Artificial Neural Network, Support Vector Machine, Decision Tree, Random Forest (RF), etc. In this study, Random Forest (RF) is used because 1) RF is an efficient classification algorithm, and 2) it only needs a very few hyperparameters to be tuned. These help with the efficiency and consistency during the evaluation process. It is noted that the other types of ML-based classifiers can also be used for leakage localization. The RF is trained with leaking samples with leakage zone labels (step 7).

With the trained models for leakage detection (PCA and AE) and model for leakage localization (RF), for each operational dataset, the leak is detected based on reconstruction error larger than the threshold θ. If a leak is detected, the data will be fed into the RF classifier for leakage zone localization. The detection and localization process for real-time monitored data is illustrated in FIG. 4B).

### WDN Operation Data Generation

The developed method for WDN leakage detection and localization can be readily applied to operational WDN. However, the monitoring data of in-service WDN is scarce. A hydraulic simulator of WDN is therefore utilized to generate a dataset to evaluate the developed framework. Simulation-based data generation is commonly used to develop ML models to overcome the limitations of physical data. For example, Tao evaluated an artificial immune network with the dataset generated by water pipeline hydraulic simulation code EPANET. Similar works have also been done by many studies. In this study, a python package WNTR is utilized to build the hydraulic model for WDN. The package implements the hydraulic model and solver of EPANET 2.2, which is an industrial hydraulic standard. It is also capable of performing Monte Carlo simulations of WDN operations under different scenarios.

By default, the hydraulic simulator considers the user node could always get designed water demand (d) even when the water pressure at that node is 0. However, due to the leakages, the supplied water demand (d*) could be less than the designed water demand (d) when the water pressure is low. Herein, a pressure-dependent water model is used to consider the influence of water pressure on the water supply at each junction, which is assumed to follow Wagner's formulas as shown in Eq. (1):

$${d}^{*} = f ( p ) = \{ \begin{matrix}0 , & p \leq {P}_{0} \\ {d ( \frac{p - {P}_{0}}{{P}_{f} - {P}_{0}} )}^{\frac{1}{η}} , & {P}_{0} < p \leq {P}_{f} \\ d , & p > {P}_{f}\end{matrix} \qquad ( 1 )$$

where p is the water pressure at the junction, d is the designed water demand, d* is the supplied water at different water pressure. P₀ is the minimum water pressure, P_{f} is the required water pressure to meet the designed water demand. η is the pressure exponent which is set as 2 in this study. The values of P₀ and P_{f} are set as 2 and 30 m respectively based on

recommendation by [42].

The equation by Crowl and Louvar is used as the leaking model. The model assumes there is a turbulent flow of water as leak occurs. The mass flow rate of the leakage is expressed by Eq. (2):

dₗₑₐₖ=C_{d}A \sqrt{2gh} (2)

where i the leaking demand which depends on the water pressure. C_{d} is the discharge coefficient which is set as 0.75 in this study. A is the leaking area in the unit of m², h is the water head with unit of m. g is the gravity acceleration (m/s²). To emulate the uncertainty of leakage size, a randomly generated value of the leaking area A is used in simulating different leaking scenarios.

The following procedures are used to generate dataset under normal (non-leaking) conditions and leaking conditions:

### Data Generation for Normal Operation Scenario of the WDN

1. Define water pipe network: Build the WDN pipe network with the corresponding pipeline geometry and material properties following EPANET data input format.
2. Set the water demands at WDN junctions: Each junction on the WDN has a design water demand. A Gaussian fluctuation is added to the design water demand as the total design water demand to consider the variations in user needs, i.e.,

Demandᵢ=D_{base}ⁱ+N(0σᵢ²)| (3)

where D_{base}ⁱ is the baseline design water demand at junction i which is defined in the original pipe network. A Gaussian term is added to consider the water usage fluctuations.
3. Data generation: With the defined water pipe network, the hydraulic model for the WDN is solved with proper hydraulic boundary conditions with the WNTR solver package. The results include all hydraulic information such as water pressure or flow rate at any location in the WDN.
   a. The results of water pressure at selected monitoring nodes under different WDN operational conditions are obtained.
   b. Gaussian noise N(0, γ) is added to the water pressure data to mimic the noise in the monitoring data (due to sensor performance or other random factors)
   c. Store the data

Steps 2 to 3 are repeated to generate data under different water demand conditions.

### Data Generation for WDN Under Leaking Scenario

Similar procedures are used to generate a dataset for WDN under the leaking scenario (Steps 1-3). Except for the effects of leakages are considered in Step 3 before solving the hydraulic model for the WDN. Leaking is assumed to occur at each junction, which is convenient for clustering purposes. The leakage size is assumed to be randomly set between 0.05 meter to 0.1 m in this study, which leads to 0.0012 m² to 0.0078 m² leaking size. These, however, can be easily changed to more complex leaking conditions.

### Example Case Study I: C-Town WDN

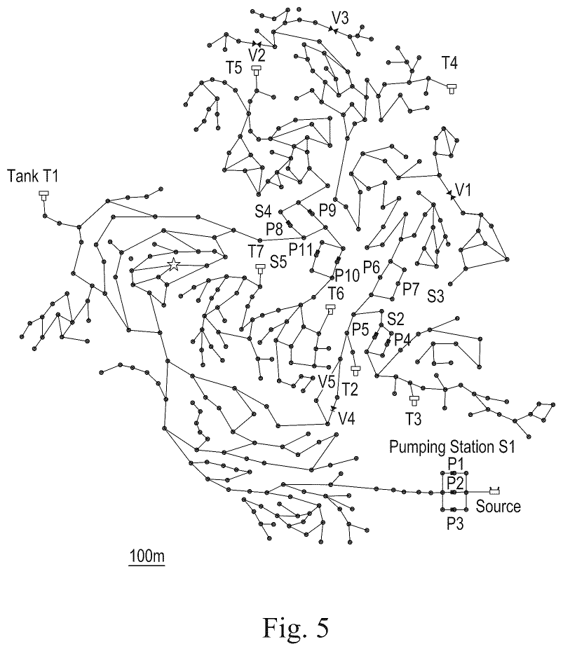

C-Town water distribution network is a WDN that was used for calibration competition in Battle of the Water Calibration Networks (BWCN). The topology of this WDN is shown in FIG. 5. The WDN has 388 junctions that are connected by 429 pipes. The water source includes 1 reservoir and 7 water tanks. The water is powered by 11 pumps and controlled by 4 different kinds of valves. Each pump and valve have its functionality which will perform differently under different water usage situations. The WDN hydraulic model includes the junction locations, pipe lengths, pipe diameters, pipe roughness, water demands, user patterns, and working rules of pumps, valves, tanks, etc. The original data of the WDN shared by ASCE include hydraulic simulation at 168-time steps. The hydraulic model for the C-Town WDN was made public after the competition. The model can be downloaded from the ASCE Library, which also includes the EPANET input format file. The details of the network can be found in the original paper.

Although the parameters of the C-Town WDN provided by the original paper are deterministic values, the uncertainties of the WDN are considered in this study by adding randomness to the parameters. For example, a Gaussian distributed random value (Eq. 3) was added to the water demand of each junction to represent the uncertainties of water demand, the standard deviation is 10% of the junction's designed water demand The leakage size of each leakage scenario was chosen from uniform distribution of 0.05 m to 0.1 m. Besides, to consider the sensor noise, a random error of Gaussian distribution is also added to the water pressure data, which has a 0 mean value and 0.1 m standard deviation. Using the EPANET model for the C-Town WDN with proper hydraulic boundary conditions, simulations are conducted on the WDN under different operational conditions (i.e., the operational rules of the pumps and valves, water demand, leakage occurrence, etc.). From these, the hydraulic data (i.e., water head and flow rate) at any location in the WDN can be obtained.

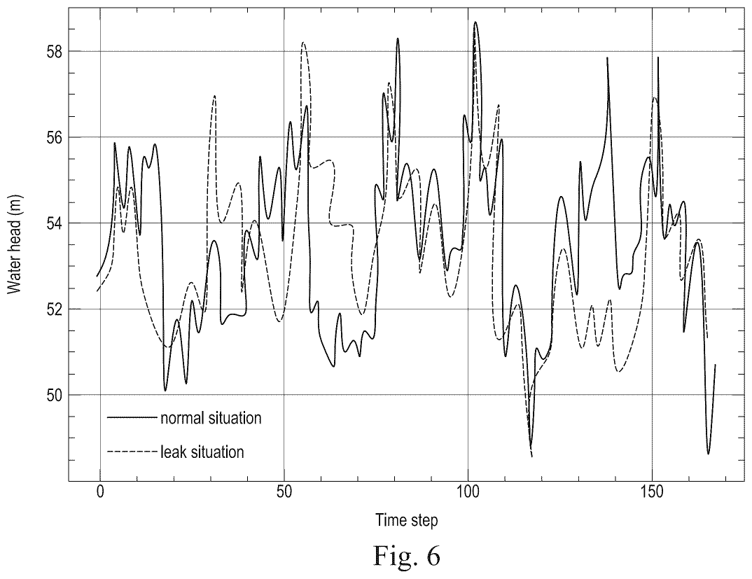

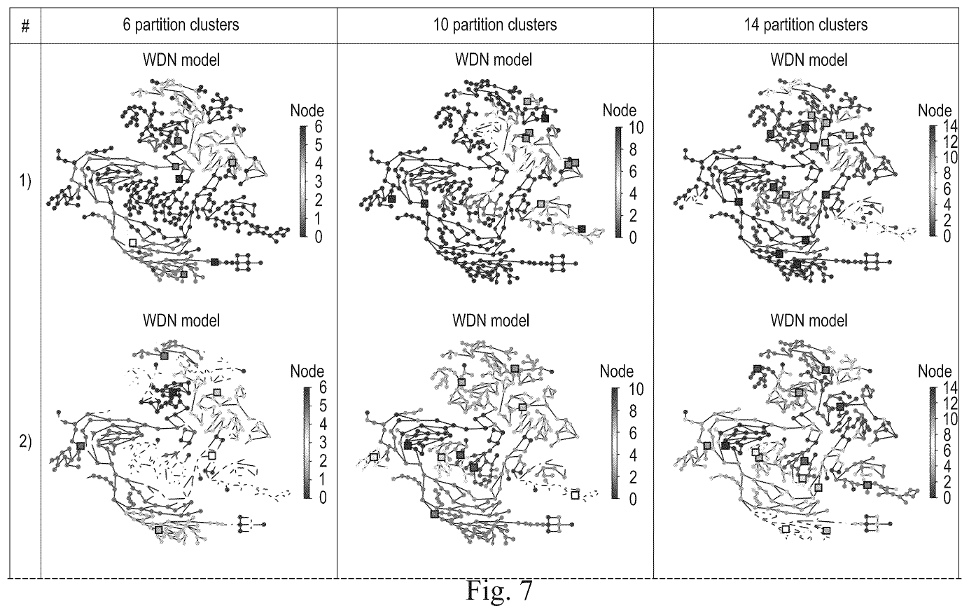

FIG. 5 illustrates a topology of C-Town water distribution network, in which T denotes tank, S denotes meter district, P denotes pumps, V denotes valves, star denotes Junction J370. FIG. 6 illustrates example of water head fluctuation under normal or leaking conditions at Junction 370, which compares the total water head at junction ‘,J370’ (noted by a star in FIG. 5) with and without a nearby leakage, which clearly shows that leakage affects the hydraulic conditions in the WDN. In FIG. 6, the water head is defined as total water head including the summation of the pressure head and junction's elevation head. It is noted that the water pressure under leaking conditions is sometimes higher and sometimes lower than that under normal conditions, possibly due to fluctuation in the WDN operational status. These make leaking detection and localization to be a challenging task.

### C-Town WDN Partition Results

The C-town WDN is partitioned following the procedures described in the section entitled WDN partition stage: modified k-means clustering algorithm. Datasets of C-town WDN were generated using the python package WNTR for both non-leaking conditions and leaking conditions via the procedures described in the section entitled WDN Operation Data Generation.

To calculate the leakage characteristic matrix, without loss of generality, a fixed leakage size of 0.05 m was assumed in the simulation, since the subsequent data normalization will take away the effects of leakage size. A leakage matrix is essential to obtain the leakage characteristics matrix for WDN partitioning. The leakage matrix is used to obtain the influence of leakage at different junctions on the monitoring locations. A fixed leakage size of 0.05 m was used to build the leakage matrix for the simplify consideration. This leakage size is selected based on the lower bound of leakage size. The effects of selected leakage size are minor since the leakage matrix be normalized to determine the leakage characteristics matrix.

To evaluate the relative performance of the proposed partitioning method, the testbed C-town WDN were partitioned into different numbers of leakage zones based on 5 different partitioning methods, which utilizes different data feature versus Euclid distance measures. These comparative approaches are described as following.
1) Standard k-means clustering using the conventional leakage characteristics matrix (Table 1), which was used in previous studies such as Zhang This is named conventional partition in this paper.
2) Modified k-means clustering using conventional leakage characteristics matrix and physical distance matrix (named as modified-partition).
3) Modified k-means clustering using PCA extracted leakage characteristic matrix and physical distance matrix (named as PCA-based partition).
4) Modified k-means clustering using AE-based leakage characteristic matrix and physical distance matrix (named as AE-based partition).
5) Modified k-means clustering only using the physical distance matrix (named as graph distance-based partition).

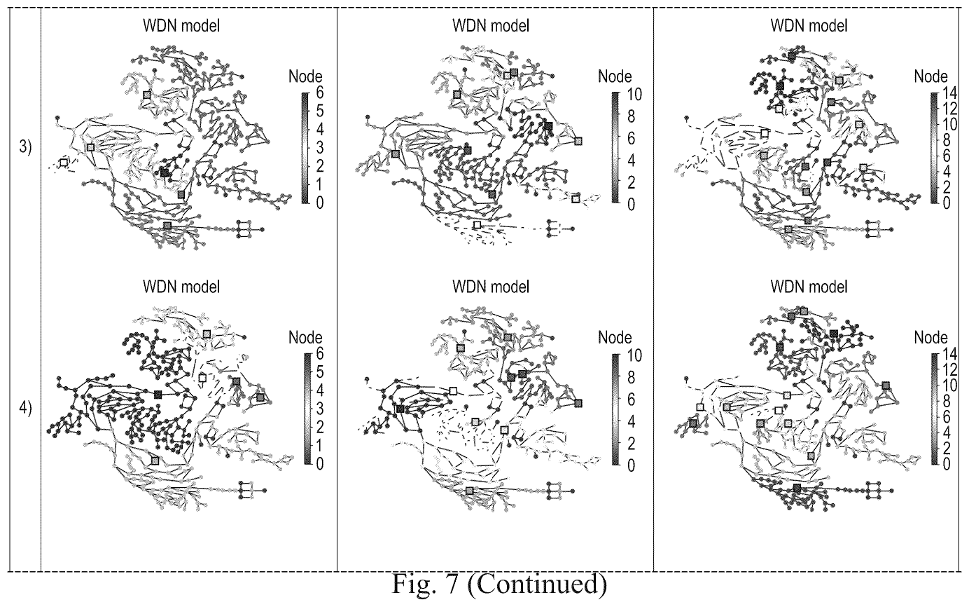

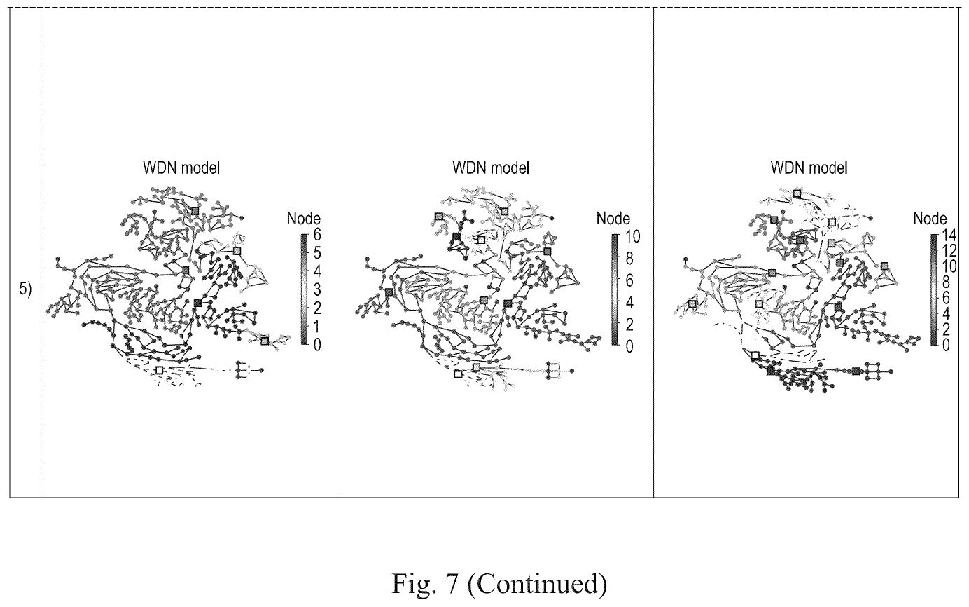

FIG. 7 illustrates results of WDN leakage zone partition with five different approaches. In FIG. 7, class 1 to k are the leakage zone IDs. Class 0 is the pump/tank/reservoir nodes, and the rectangular structure denotes the pressure sensor location. In FIG. 7, the results of WDN partition into different numbers of clusters (6, 10, and 14) by the five different partition procedures. Junctions of the cluster are represented with different colors, with the centroid of each cluster indicated with a rectangle symbol with the same color as its cluster.

As shown in FIG. 7, Subgraph 1 indicate that conventional partition using the traditional k-means algorithm without the consideration of the graph distance between junctions, the junctions in clusters are scattered and intermingled. The scattering increases with the increasing number of partition zones. From Subgraph 2, the modified partition based on modified k-means clustering algorithm effectively reduces the scattering since it considers the graph distance of junctions in addition to the conventional leakage characteristics. This leads to a much smaller number of isolated junctions. Comparison of Subgraph 3, 4 versus 2 shows that PCA-based partition and AE-based partition further reduce the scattering based on raw leakage characteristic matrix. PCA-based partition and AE-based partition achieved comparable results. It is noted that the AE-based partition of the C-town WDN took more than 10 hours while the PCA-based partition required only a few minutes. The main reasons include the AE method needs more time for training and requires more iteration times to get convergence. A potential solution is using regularization methods for AE-based partition.

### C-town Leakage Detection

The leakage detection is demonstrated on the clustering result when the C-town WDN is partitioned into 10 clusters by PCA-based partition. The monitoring sensors are assumed to be installed at the centroid of each cluster and the corresponding data are used (shown in FIG. 7 (3) by rectangles) for leakage detection. PCA and AE models are used for leakage detection.

With the data generation procedures outlined in the section entitled WDN Operation Data Generation, the dataset with 1000 non-leaking samples under different operation conditions of the WDN is generated. The non-leaking data are randomly split into a subset of 700 and 300 samples. Then, 300 leaking samples were generated by setting a random leakage size at a randomly picked junction. The subset of 700 non-leaking samples is used as the training dataset. The subset of 300 non-leaking samples together with the 300 leaking samples is used as the testing dataset.

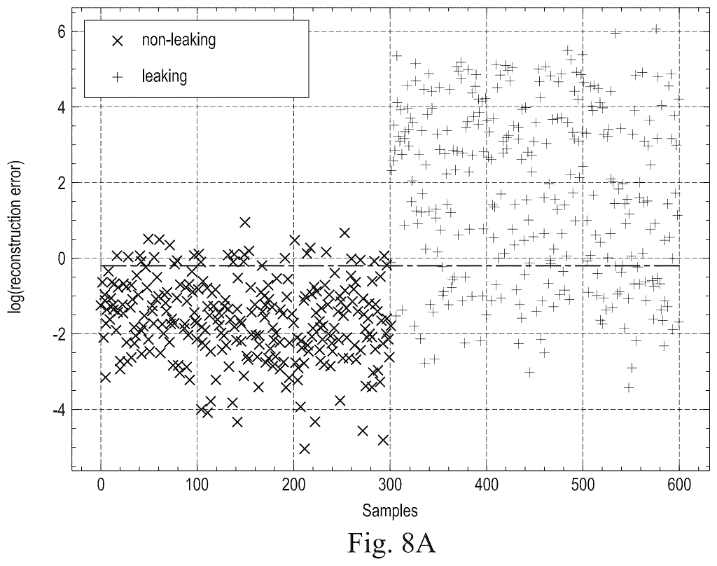

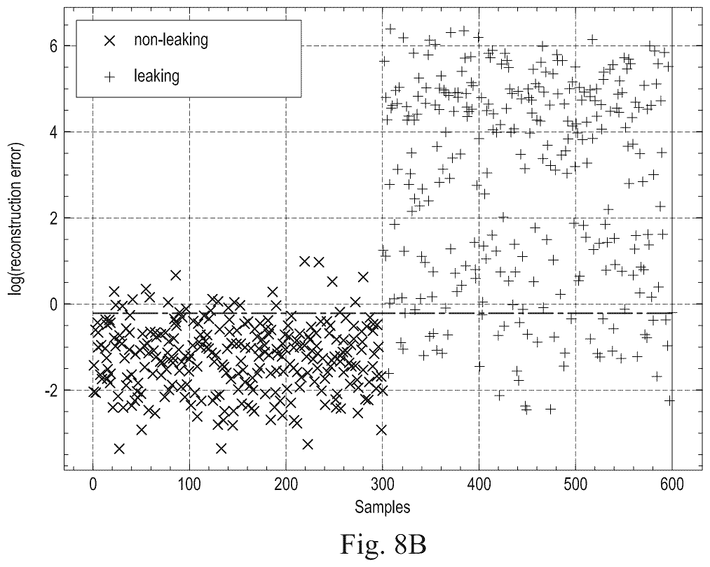

The ML-based leakage detectors (AE model or PCA model) are firstly individually trained with the training dataset (700 non-leaking samples). With the trained ML models, the testing datasets are fed as inputs. The reconstruction errors of the input data by the AE detector and PCA detector are shown in FIG. 8. The models feature larger reconstruction error with leaking samples than non-leaking samples, which is the basis for differentiating leaking versus non-leaking cases. A threshold can be set to achieve the best leaking detection performance For practical implementation, this threshold can be empirically set initially based on statistical analyses of the reconstruction error distribution with monitored data under non-leaking condition. For example, the maximum value or third quantile value can be used. It can be fine-tuned when more leaking data become available.

If the reconstruction error of a non-leaking sample is smaller than the threshold or a leaking sample is larger than the threshold, this sample will be recognized as correctly classified. Misclassifications happen with the set threshold, i.e., leaking samples are classified as non-leaking, or non-leaking samples are classified as leaking. The leakage detection accuracy is assessed by the number of correctly classified cases over the total number of testing samples.

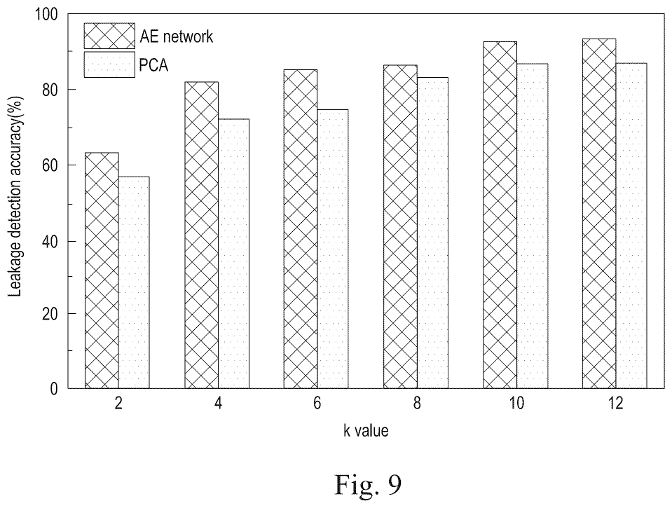

FIG. 9 illustrates leakage detection accuracy with two different unsupervised ML models under different number of partitions (k value). The leakage detection performance of PCA and AE detectors (e.g., from FIGS. 8a and 8b) when the WDN is partitioned into different numbers of leakage zones is summarized in FIG. 9. Since monitoring data are assumed to be at the centroid of each partition, the dataset for each number of partitions has to be regenerated for each case using the data generation process described in Section entitled WDN Operation Data Generation. The size of training dataset and testing dataset are kept the same throughout. To overcome the uncertainties during the data generation, the average accuracy of 5 cross-validations is reported for each case. As shown in FIG. 9, the leakage detection accuracy steadily increased with the increasing number of WDN partitions. It is understandable since the more sensors deployed in the WDN, the more water leakage scenarios would be covered. The results also show that the AE leak detector overperforms the PCA detector by about 5%.

### C-Town Leakage Zone Localization

Besides detecting leakage, localizing the leakage is also important for retrofit actions on the WDN. Conventional supervised ML classifier requires training dataset must include data of leaking occurring at each WDN junction. In practice, however, leakage only appears at limited locations, which makes it infeasible to well train a supervised ML model. With the partition of WDN, the leakage localization problem is defined as a semi-supervised classification problem. The Random Forest (RF) model is chosen for leakage zone localization following the procedures outlined in FIG. 4B.

The leakage localization performance of using different partition methods is firstly evaluated in WDN by partitioning the WDN into 6 leakage zones. A small portion of total junctions (assumed as 10% in this study which can be changed to other assumptions without loss of generality) are assumed to have experienced leakage. The leaking junctions are assumed to be evenly distributed among the 6 partition zones. Based on this assumption, leaking data samples are generated by assuming a leakage of random size occurring at one of these selected junctions. For each of the 6 partition zones, 400 leaking data samples are generated. Therefore, the total training dataset includes 2400 data samples, with their respective labels of partition zones they belong to.

For the testing data, 200 leaking data samples are randomly generated assuming leakage of random size occurring at randomly picked junctions in the remaining 90% junctions. Altogether, the testing dataset includes 1200 leaking samples.

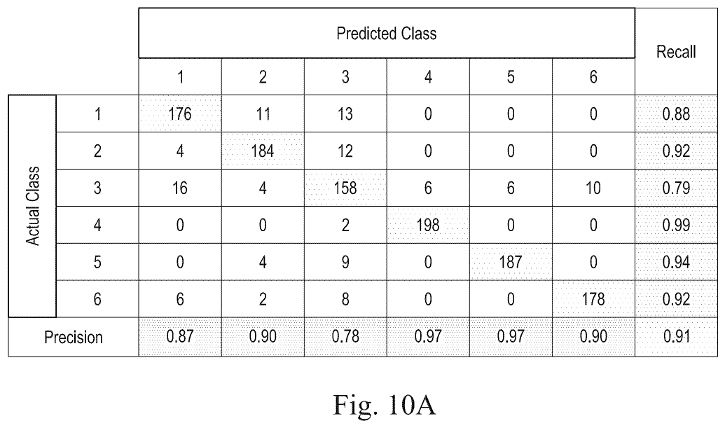

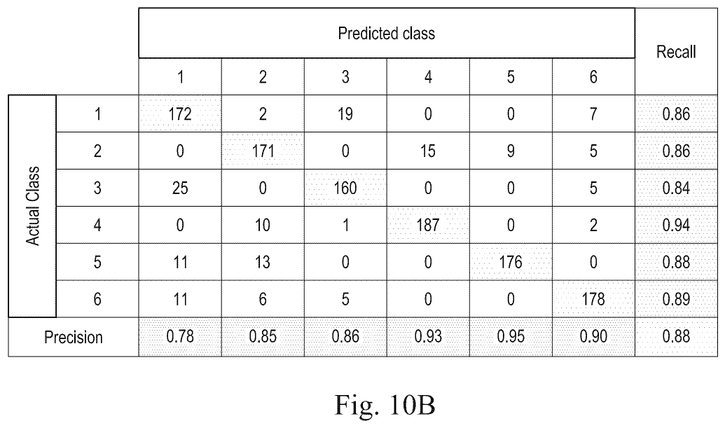

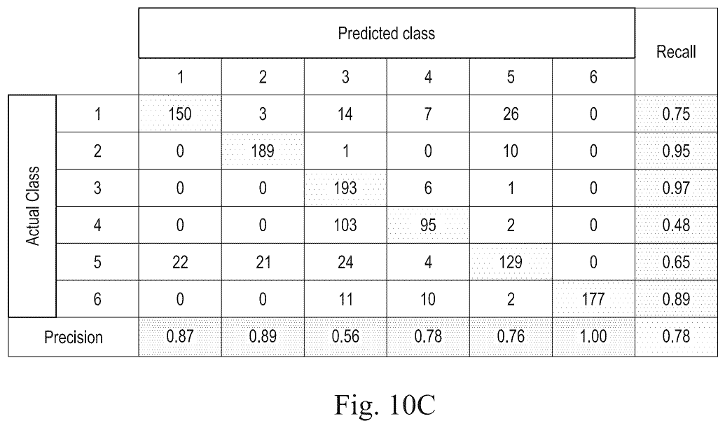

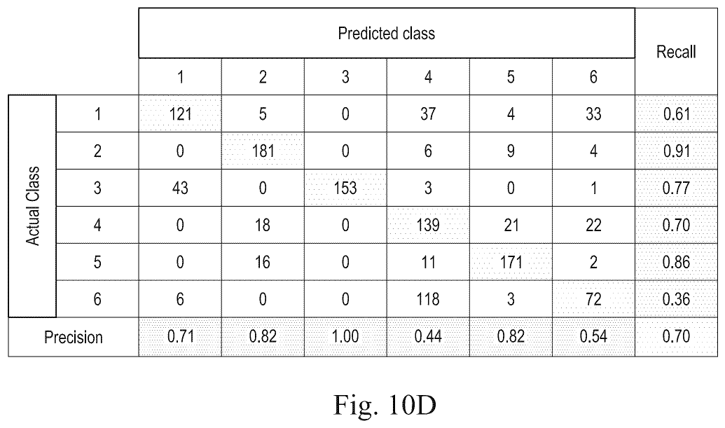

A confusion matrix is often used to evaluate the classification performance, which is also used for leakage localization performance in this study. A typical confusion matrix contains four prediction terminologies: True Positive, True Negative, True Positive, and False Negative. For a multi-classification confusion matrix with a structure like FIG. 10, the True Positive indicate the number of correctly predicted samples, the rest rows of each class are False Positive, and the rest columns are False Negative. The accuracy, recall value, and precision matrices are used for evaluation since this is a balanced testing dataset. For a better understanding, the equations to compute each matrix is shown in Eqs (5), (6), (7).

$$acc = \frac{{\sum }_{i = 1}^{k}}{sum ( M )} \qquad ( 5 )$$

$${Recall}_{i} = \frac{{M}_{ii}}{{\sum }_{j = 1}^{k} {M}_{ij}} \qquad ( 6 )$$

$${Precision}_{i} = \frac{{M}_{ii}}{{\sum }_{j = 1}^{k} {M}_{ji}} \qquad ( 7 )$$

where M is the confusion matrix, i is the i^{th} class, k is the total number of classes. Mᵢⱼ indicates the i^{th} row and j^{th} column.

The RF leakage zone detection is implemented on WDN using different partition methods, i.e., AE-based partition, PCA-based partition, Modified Partition, and Graph distance-based partition. The confusion matrices of the final leakage localization results are shown in FIG. 10. From the comparison, the RF-based leakage localization using PCA-based partition achieved the highest accuracy of 91% (FIG. 10A). This is followed by 88% accuracy using AE-based partition (FIG. 10B), 78% accuracy using modified partition (FIG. 10C), 70% accuracy using graph distance-based partition (FIG. 10D).

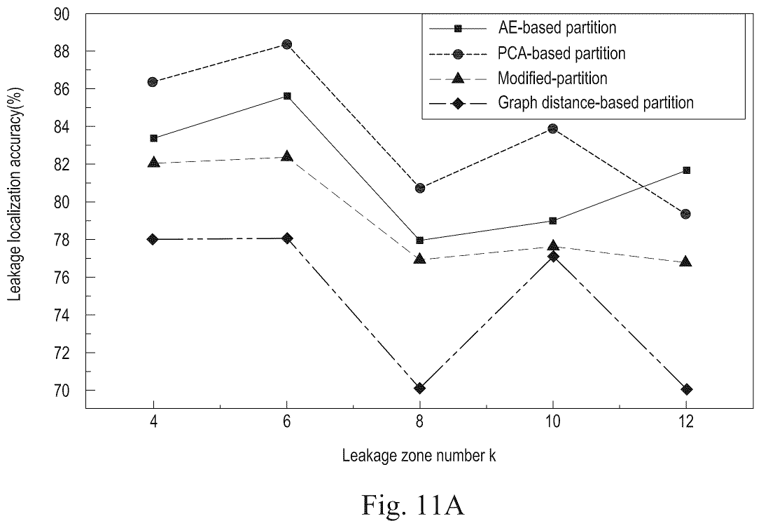

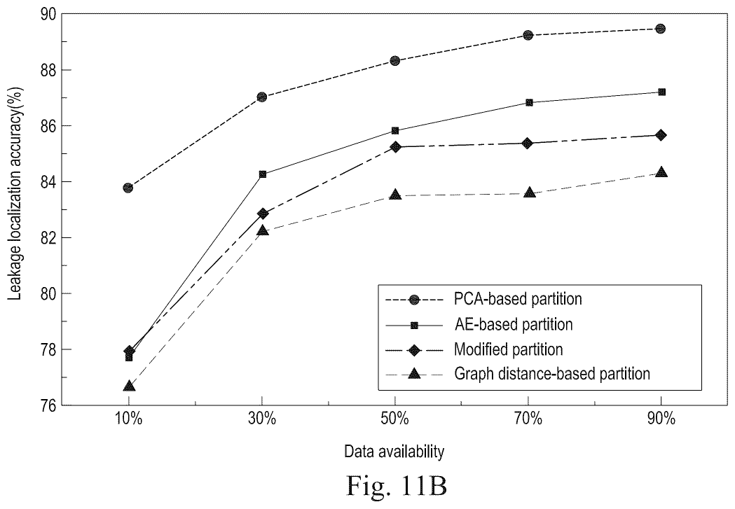

FIGS. 11A and 11B illustrate leakage localization accuracy with an RF model. The effects of the number of WDN partitions on the leakage zone localization accuracy are further evaluated and summarized in FIG. 11A. 20 trials are conducted for each case to eliminate the randomness and the average accuracy is plotted. The accuracy in leakage localization by RF consistently achieved top 2 performance by using AE-based or PCA-based partitions. FIG. 11B shows accuracy under percentage of junctions with leakage data available (e.g., for WDN with 10 partitions). The accuracy of localization is worst when only considers the physical distance of junctions with no consideration of the leakage characteristics. It is noted that leakage zone localization using AE-based partition started to overperform that using the PCA-based partition for a larger number of partitions (i.e., 12). This might be attributed to that AE-based partition is more capable of identifying complex relationships from the data.

### Hybrid Approach for Leakage Detection and Leakage Zone Localization

The analyses so far indicate that the AE model achieved higher accuracy than the PCA model for leak detection, possibly due to its ability to extract non-linear relationships among the input features. Meanwhile, the RF-based leakage localization achieved the highest accuracy when using PCA-based WDN partition, possibly because the PCA-based information extraction is easier to be learned by RF. PCA also features higher computing efficiency. Therefore, a hybrid framework is proposed that combines the use of PCA-based partition, AE-based leakage detection, and RF-based leakage localization.

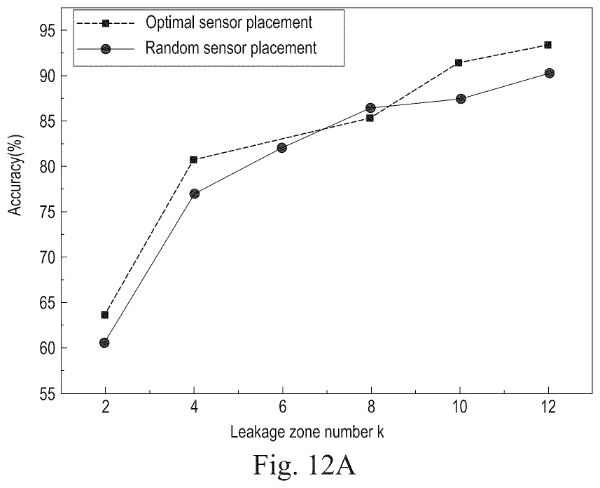

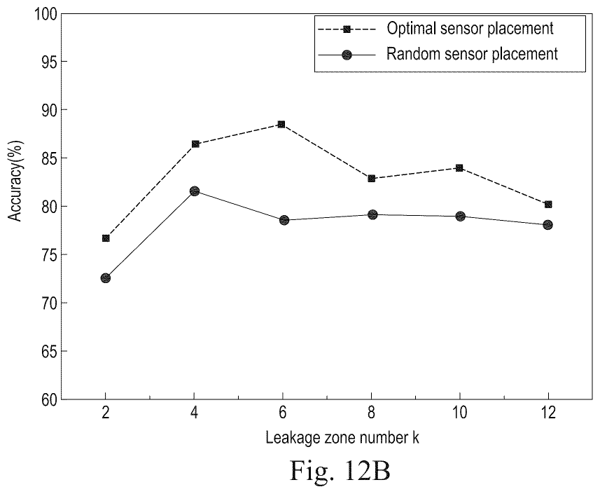

In practice, resource constraints might prevent sensors to be installed at the most optimal junctions. To consider such issue, analyses are conducted under the scenery where sensors are assumed to be ‘randomly placed’ in the WDN and the leakage zones are clustered using these sensors as the centroids. The accuracy of leakage detection and localization under ‘optimal sensor placement’ and ‘random sensor placement’ are determined using the C-Town WDN testbed. The final results are summarized in FIG. 12. The results of random sensor placement are the mean values of 10 different random sensor deployment scenarios.

FIGS. 12A and 12B illustrate comparison the influence of sensor placements on the performance of the developed CtL-SSL framework, in which FIG. 12A shows leakage detection accuracy, and FIG. 12B shows leakage localization accuracy. As seen in FIGS. 12A and 12B, deployment at non-ideal locations slightly compromises the accuracy of the proposed leakage detection and localization method. However, it still achieved an overall accuracy between 70% and 80%. The overall performance is regarded satisfactory. This is vindication of the accuracy and robustness of the developed method. It is also observed from FIG. 12B that the differences in the detection accuracy under optimal versus non-optimal sensor locations diminishes with the increasing number of leakage zones. With more leakage zones partitions, more sensors are placed in the WDN. Placing sensors at optimal locations become less important for the developed leakage detection framework.

Initially, the proposed framework is illustrated by defining distance L_{v,c}_{ⱼ} as the average distance of leakage characteristics distance and graph shortest path distance. The sensitive study about the different penalty weights of the leakage characteristics distance and graph distance is conducted here based on the hybrid partition and detection framework. In detail, the distance is redefined as Eq 4. The target leakage zone number (k) is set as 10 for the illustration purpose.

L_{v,c}_{ᵢ}=w₁*L_{(v,c}_{ⱼ}₎^{leakage}+w₂*L_{(v,c}_{ⱼ}₎^{physical} (4)

s.t. w₁|w₂=1

where w₁ is the weight assigned to the leakage characteristics distance and w₂ is the weight assigned to the physical distance.

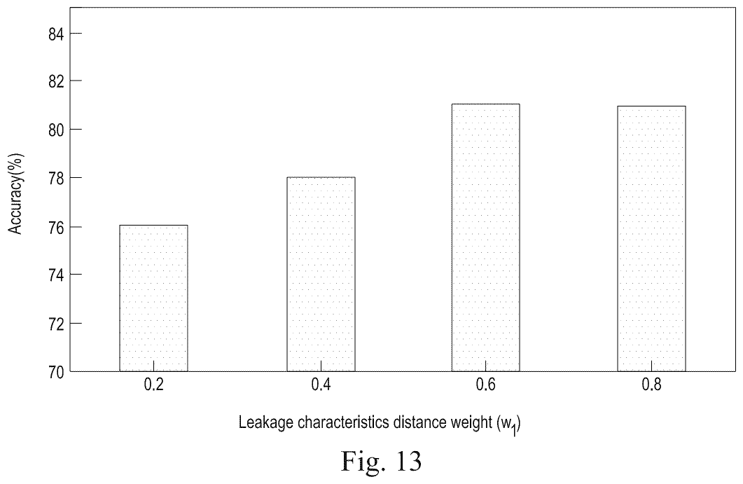

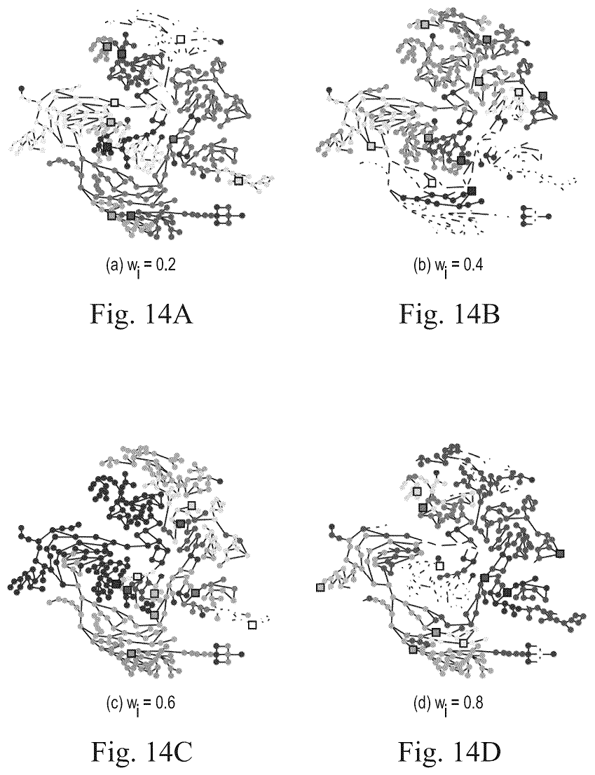

Sensitivity analyses are conducted on the effects of weights assigned to the leakage characteristic distance. The final leakage localization accuracy when using different values of w₁ is shown in FIG. 13 and the corresponding WDN partition results are shown in FIG. 14. The results indicate the leakage localization framework achieved higher than 76% when 20% weight is assigned to the leakage characteristic distance (80% weight by the physical distance). The performance improved with increasing weight of the leakage characteristics. However, about 60% weight, the performance improvement becomes insignificant. Meanwhile, a more scattered leakage zone partition result is observed when the leakage characteristics is given higher weights, as demonstrated in FIG. 14. These observations indicate that an optimal weight exist that achieves balanced consideration of the leakage localization accuracy and the leakage zone scattering degree.

### Example Case study II: Rancho Solano Zone III WDN

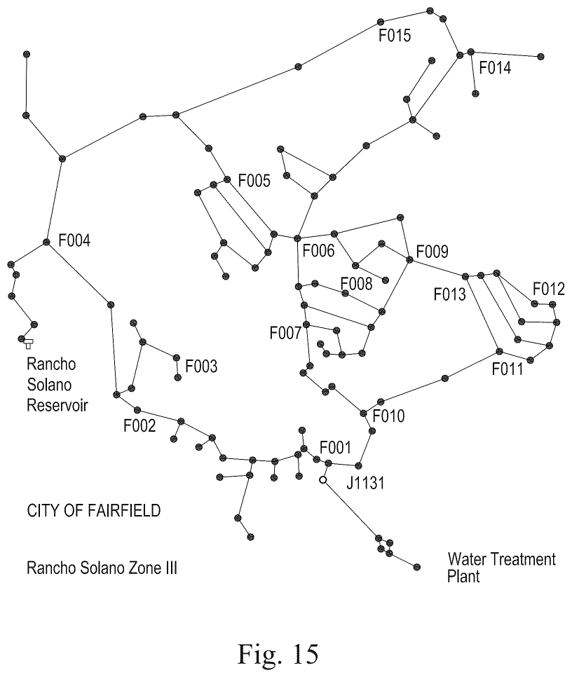

To further illustrate the proposed leakage partition, detection, and localization framework, another WDN, Rancho Solano Zone III WDN is used as the second independent testbed. This testbed is located in Fairfield, California. The information about this WDN is published by ASCE task committee on a research database for water distribution systems and are open to download from the database of Kentucky University. The graph of this water supply network is shown in FIG. 15. There are 112 nodes in total, including one reservoir and one water treatment plant as the source of water, and 126 pipes. The elevations of the nodes in this pipe network range from 90 m to 120 m and the length of the pipes range from 90 m to 130 m. The original data of water demand and water supply conditions for this WDN are used in this study.

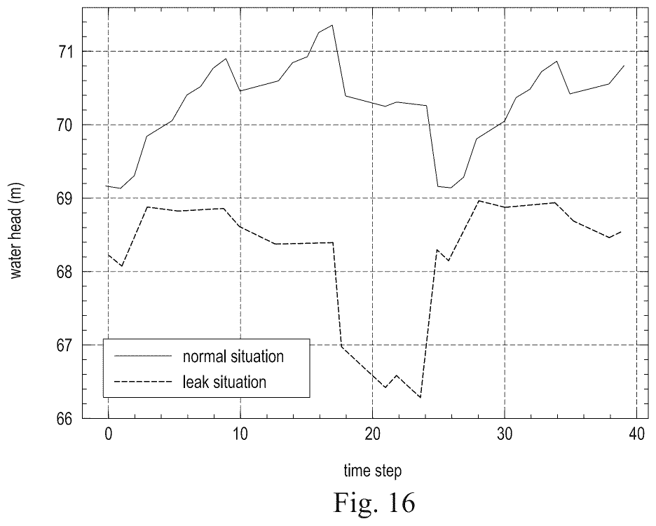

The same uncertainties of water demand and sensor noise that are considered in the Case study I are used again in this testbed. The leakage uncertainty range is set as U(0.01, 0.05) since a too large leakage size could directly drainage all the water in this WDN. A 40 time steps water pressure record of Junction ‘F010’ is shown in FIG. 16 to illustrate the influence of a nearby leakage.

### Rancho Solano Zone III WDN partition results

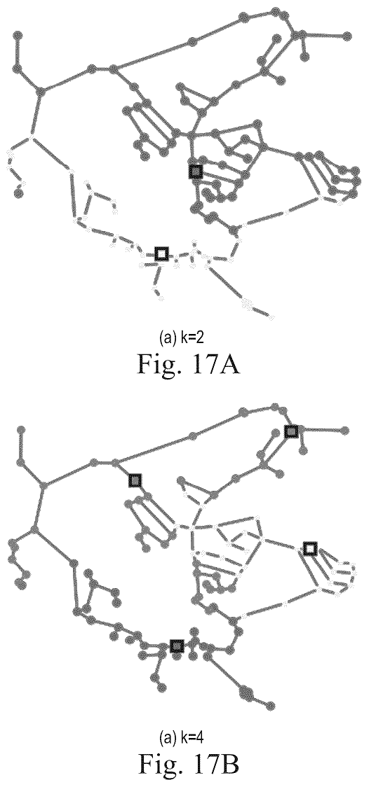

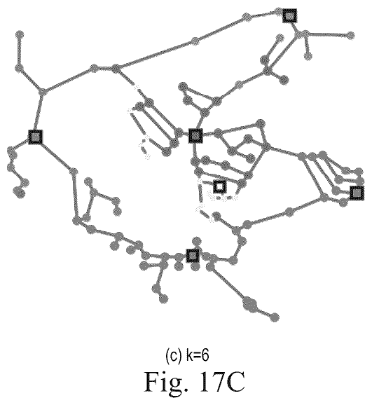

The proposed hybrid framework, as described in section entitled Hybrid approach for leakage detection and leakage zone localization, is applied on the Rancho Solano Zone III to illustrate the effect of WDN partition results. The considered leakage zone numbers are 2, 4, and 6 in this study. When using an equivalent penalty weight of the leakage characteristics and physical distance, the final partition results when considering different numbers (k) of partition zones are shown in FIG. 17.

As can be seen from the results, the partitioned results are reasonably balanced and concentrated. Hence the maintenance team can easily narrow down the inspection area after a leakage is detected.

### Rancho Solano Zone III Leakage Detection and Localization Results

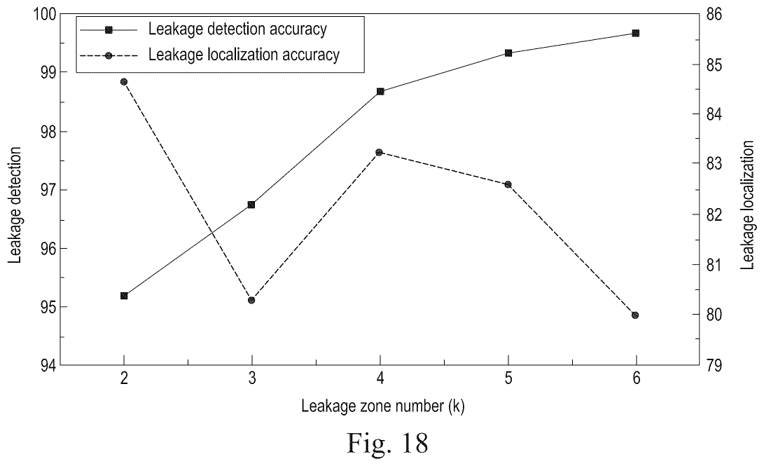

Similar to Case study I, only non-leaking monitored water pressure data is used for leakage detection and only 10% of junctions of each leakage zone are assumed to have leakage experience. Hence the recorded water pressure under available leakage experiences can be used for the leakage localization model training. A similar preparing process for the training dataset and testing dataset in Case study I is also used here. FIG. 18 shows the final leakage detection accuracy and leakage localization accuracy when the WDN is portioned into different numbers of leakage zones. As can be seen from the results, the leakage detection accuracy increases with the increasing number of leakage zones which is also the number of placed sensors. It is understandable since the more sensors the higher chances that one of them could be impacted by the leakage. For a small scale WDN like Rancho Solano Zone III, the water pressure of each junction is sensitive to any leakage situation, so the leakage detection achieved about 95% even with two sensors. On the other hand, the leakage zone localization accuracy fluctuates from 80% to 86% when partitioning the WDN into a different number of leakage zones. The overall accuracy is still acceptable.

### Conclusions

A novel CtL-SSL framework is developed for WDN leakage management in this study. The framework includes WDN leakage zone partition, leakage detection, and leakage zone localization. The WDN partition is based on the leaking behaviors of the WDN junctions. New leakage characteristics are defined based on features extracted from non-leaking data with unsupervised ML models such as PCA or AE. Improved k-means method is proposed for WDN partition, which considers the graph distance between junctions and the leakage characteristics. Sensors are recommended to be installed at the centroid junction of each partition to acquire monitoring data. With the monitoring data, unsupervised ML models are developed for leakage detection based on threshold criteria of reconstruction errors. This allows leakages to be detected with unbalanced dataset that contains non-leaking samples only. With the leakage zone partition of the WDN, the leakage zone localization is defined as a ML-based classification problem using partition zone numbering, which is achieved with a small percentage of leaking data.

The results indicate the new partition algorithm (stage 1) achieves less intermingling of junctions from different partitions compared with the conventional partition method. The leakage detection and localization stage (stage 2) also gained promising performance even with leakage data over only a small portion of junctions. The proposed framework achieved around 95% accuracy in leakage detection and 83% leakage localization accuracy in both case studies with less than 10% of junctions' leakage data.

The proposed CtL-SSL framework can be easily used on different WDNs and updated with more powerful models in the future, which increases its extensibility and upgradeability. The final performance may vary when the number of leakage zones and scales of WDNs are different. Determining the optimal number of leakage zones for different types of WDN is still a problem worth future investigation. In practice, an optimal number of leakage zones should not only consider the final detection and localization accuracy but also factors such as budget limitation, expected leakage zone resolution, social-economic impact, and so on. Moreover, the systems and method described herein can be developed and validated by use of data generated by use of hydraulic model for WDNs.

### Hybrid Machine Learning Model for Resilient Water Distribution Network Repair Decisions

Methods to quantify the WDN resilience have been an active area of research in recent decades. These methods can be divided into two major categories, i.e., surrogation-based quantification and recovery-based quantification. The surrogation-based resilience quantification treats the WDNs as static systems (typically before disruption) without considering their time-dependent performance after the disruption. Energy-based and graph-based analyses of WDN are two of the most commonly used surrogation-based methods for resilience quantification. For example, Todini proposed a WDN resilience quantification method based on energy dissipation during the water distribution process. Prasad et al. further enhanced Todini's method by considering the redundancy of the network. Jayaram et al. proposed another surrogation index for WDN resilience quantification by considering multiple water supply sources in one network. Zarghami et al. quantified the water distribution network resilience based on the betweenness centrality and information entropy theory.

Given the important role of recovery decisions on WDN resilience, different models have been proposed in previous research to improve decisions on system restoration sequence. However, due to possible large number of failures and complex hydraulic relationships in a WDN, determining an optimal restoration sequence to maximize system resilience remains a challenging problem. Current methods for optimal WDN system restoration decisions can be categorized into two major categories, i.e., recovery methods based on the static importance of WDN components and resilience-oriented recovery methods.

The first group of methods ranks the WDN components based on a static measurement of their importance in the WDN. The common importance indicators are based on the graph theory such as the betweenness centrality of the nodes or operational energy such as the distance to the source, or pipe entropy values. Overall, this group of methods does not require evaluating the dynamic recovery process. On the other hand, the resilience-oriented methods, typically involve a hydraulic model for the WDN and require defining an optimization problem to assess the efficiency of the recovery process which are solved with dynamic optimization algorithms Based on the computing algorithms, the dynamic optimization algorithms are further categorized into local optimization methods and global optimization methods. Local optimization methods are based on exhaustive search that only achieve local optimal. For example, Liu et al. compared static importance-based pipe recovery method with dynamic importance-based pipe recovery method. The global optimization algorithms are aimed to achieve a global optimal solution. The widely used conventional methods include Genetic Algorithm (GA), fuzzy logic model, and Bayesian network. These algorithms, however, are computationally intensive and can lead to unstable solutions. For example, Liu et al. denoted that the GA method underperformed the local optimization methods when using a random initial population.

This description further provides a hybrid machine learning (ML) model programmed to determine the optimal WDN restoration sequence post-earthquake. The ML model, referred to herein as GCN-DRL model, integrates Deep Reinforcement Learning (DRL) and Graph Convolutional Neural network (GCN). The GCN-DRL model utilizes GCN to encode the topological information of WDN and uses the DRL framework to identify the optimal restoration sequence to maximize the SRI during the recovery process. The proposed method belongs to the resilience-oriented global optimization methods. Low computing efficiency is a general barrier of global optimization methods. The proposed method overcomes this limitation by transfer learning strategy, where the pre-trained GCN-DRL model is used to save the training needs and reuse for new disasters. This therefore achieves high computing efficiency for long-term recovery management by experience accumulation.

The following section of this description is organized into parts that describe the following features: 1) the dynamic demand-based seismic resilience evaluation framework, which consists of a model for pipe failure prediction, a model for WDN performance measurement, and a model for WDN resilience quantification; 2) on the background of Deep Reinforcement Learning (DRL) and Graph Convolutional Neural network (GCN). This is followed by the description of the detailed architecture of the developed GCN-DRL Hybrid ML model; and 3) describes the application and performance of the proposed ML model for a widely used WDN testbed.

### Theoretical Framework for WDN System Post-Earthquake Performance Recovery and Resilience Assessment

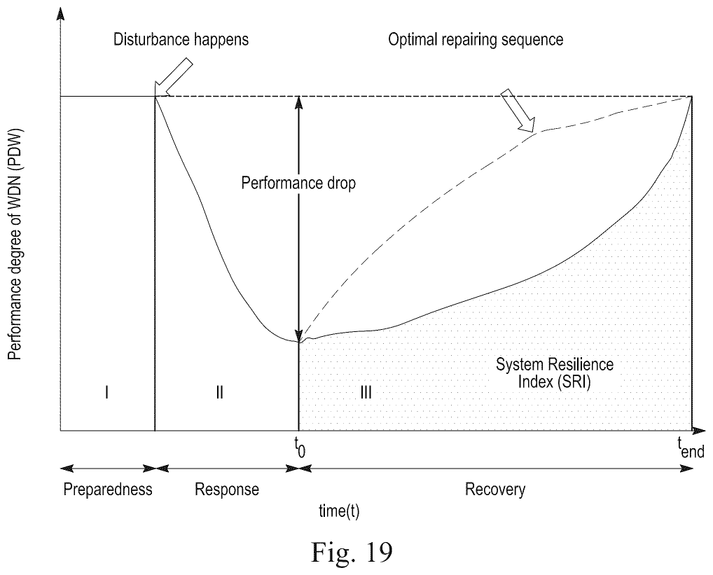

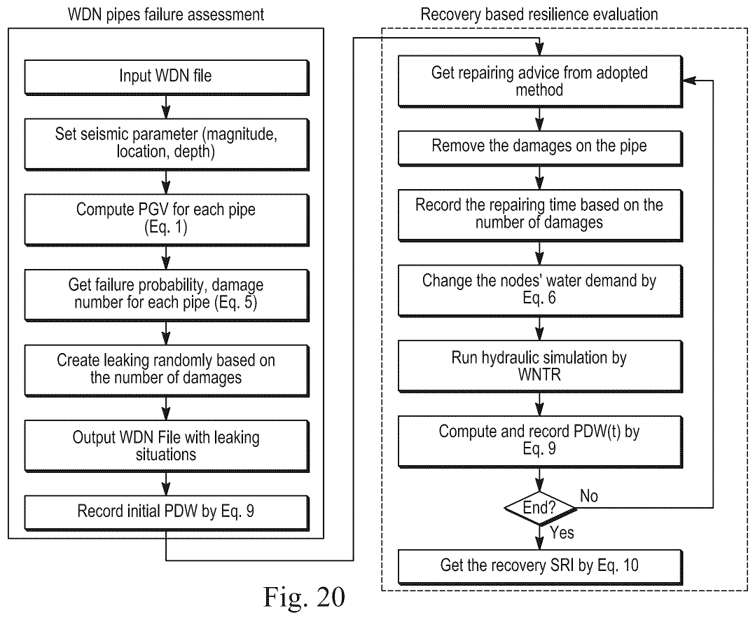

FIG. 19 illustrates an example of WDN system performance prior, during, and after disruption by hazards, the characteristics of which define system resilience. In FIG. 19, t₀ and t_{end} denote the start and finish of the recovery process, which includes performance disruption stage during hazards (Stage II) and performance recovery post-hazards (Stage III). The behavior of system recovery stage is an important part of the system resilience. The faster the system recovers from disruption, the more resilient the system is. Therefore, the recovery-based resilience quantification favors the implementation of proper methods to recover the system performance after hazard events. The time-dependent post-hazard performance curve is widely used to quantify the system resilience. FIG. 19 further illustrates the concept of system resilience index (SRI) used herein, which is defined as the area under the system performance curve shown as the gray area in stage III. With an optimal repairing sequence (i.e., the dashed curve), the system will achieve a faster performance recovery and higher SRI. This demonstrates the importance of recovery decisions on system resilience.

Additionally, the concept of time-dependent system performance degree (PDW(t)) post hazards is utilized to measure the system resilience by the system resilience index (SRI) (see, e.g., FIG. 19). In examples described below, the water distribution network (WDN) is assumed to be subjected to earthquake damages. Also, or as an alternative, other sources of damage can be used in other examples. The performance of the WDN system is indicated by its capability to meet the water use demands of customers after earthquake. An analysis framework is developed for the WDN system seismic damage prediction and resilience assessment.

FIG. 20 shows the overall procedures to implement the proposed recovery-based resilience evaluation framework on system repairing strategies. The framework can be implemented as executable instructions that integrate the components of seismic failure prediction, system performance evaluation, and system resilience quantification. Details of these components are described below. The overall procedures include:
1) To implement this framework, a hydraulic model of the WDN is firstly constructed. This requires to collect the basic hydraulic information of the WDN, such as WDN topological connection structure, pipe length, water user demands, etc.
2) Then, the seismic damages on the WDN is predicted based on the seismic vulnerability of WDN, from which the damaged pipes and the corresponding number of leakages are determined. This is input to the hydraulic model to define the initial WDN performance (PDW) after earthquake before the recovery stage begins.

The system recovery stage includes the effects of repairing damaged pipes on the WDN performance The leakages are removed for the selected pipe and the repairing time is recorded based on the number of leakages. Since a dynamic changing water demand is considered, the nodes' water demand is changed before conducting the hydraulic simulation (section entitled Quantify the WDN System Performance Degree Considering User Demand-Change and Node Importance during Post-Earthquake Recovery Process). In the end, the WDN performance (PDW) of the next time step can be determined by section entitled WDN system resilience measurement based on WDN recovery process. The repairing process is repeated until all the failure pipes are repaired. The final system resilience index (SRI) is determined (see Eq. 10). A novel GCN-DRL ML model are evaluated for recovery decisions, which is also compared with four conventional methods used for repairment decisions (pipe repair sequence).

### Assessment of the Seismic Damages of WDN and the Impacts on the System Performance Degree

Various components of WDN, including pipes, tanks, pumps, and water treatment facilities, could all be subjected to different extents of damages by earthquakes. To simplify the analyses without the loss of generality, this paper focuses on the repair sequence of distributed components, i.e., pipelines. The localized facilities (i.e., tanks, pumps and water treatment facilities) are not considered in the analyses. The accepted relationship between peak ground velocity (PGV) and pipe repair rate is used to describe the pipe fragility curve. The model was originally proposed by ALA (2001) guideline and further improved by Mazumder et al. with the consideration of pipe deterioration conditions. For the PGV estimation of an earthquake event, an empirical equation, Eq. (1), proposed by Yu and Jim is adopted in this paper, since it is developed with a dataset collected at a similar location to the testbed WDN of this study.

PGV=1.0^{-0.848+0.775M+1.83+log(R÷17)} 1

where R is the distance from the epicenter (km) and M is the magnitude of the earthquake.

With the information of PGV, the pipe failure probability with the consideration of deterioration is written as (Mazumder et al.):

P_{f}=1−e^{-k}^{₁}^{k}^{_{c}}^{+0.00187+PGV} 2

where P_{f} is the pipe failure probability every 1,000 feet (304.8 m). k₁ and k_{c} are the correction factors that consider the effects of pipe material, size, soil type, and age. Examples of recommended values of k₁, k_{c} for different pipes are provided in Mazumder, R. K., et al., Framework for seismic damage and renewal cost analysis of buried water pipelines. Journal of Pipeline Systems Engineering and Practice, 2020. 11(4): p. 04020038.

Multiple damages along a single pipe are considered in this study. The probability of the damage number of a pipe is assumed to be Poisson distributed, which is mathematically described as following.

$$P ( m ) = \frac{{( λ ( \frac{L}{L 0} ) )}^{m}}{m !} {e}^{- λ ( \frac{L}{L 0} )} \qquad 3$$

where P(m) is the probability of m damages occurring in the pipe; λ is the parameter of Poisson's distribution; L is the total length of the pipe, L0 is a reference length of 1000 ft (304.8 m) (therefore m defines the damage number of every 1000 ft (304.8 m)).

The parameter λ of Poisson's distribution in Eq. (3) can be estimated based on the probability where no-failure occurs on the pipe by using Eqs. 4 and 5.

$$P ( m = 0 ) = 1 - {P}_{f} = {e}^{- λ ( \frac{L}{L 0} )} \qquad 4$$

$$λ = - \frac{ln ( 1 - {P}_{f} )}{( \frac{L}{L 0} )} \qquad 5$$

For each seismic hazard consequence simulation, the number of failures along each pipe is randomly sampled with the corresponding Poisson distribution (Eq. (5)). The position of the damages is assumed to occur at random locations along a pipe. The effects of seismic damages on the operation of WDN are simulated by assuming that the damages will cause leakages in the pipelines. In principle, the leaking sizes vary with the extent of damages to the pipes. For simplicity, the damages are simulated as leaks with the size of 25% of the pipe cross-section area in this study. This, however, can be easily extended when more accurate information are available for a specific WDN. The seismic failure assessment of the water pipe network is coded by Python scripts. The WDN under normal operation and post-earthquake failure conditions are simulated by a hydraulic simulation solver WNTR. WNTR is an open-source python package for hydraulic simulations of the water pipe system, which solves the same sets of equations as the widely used EPANET 2.2.

### Quantify the WDN System Performance Degree Considering User Demand-Change and Node Importance during Post-Earthquake Recovery Process

The performance of the WDN is measured by its capability to meet the customers' water use demands Given the essential role of clean water supply to public life, it should also be one of the most important criteria for post-hazard restoration decisions. The water user nodes satisfaction degree (NSD) is used to quantify the performance of the system in this study. The NSD is defined as a ratio of the expected water use at the node and actual water supplied to the node. The water demand of each node has been found to experience a dynamic change process post-earthquake. Didier et al. studied the post-earthquake water demand behaviors after the 2015 Gorkha Earthquake. The results showed that the expected water demand decreased significantly due to damages to buildings and equipment when subjected to a high level of damages. For simplicity, a quadratic model is used to describe the time evolution trends of water demand post-earthquake, i.e., a disruption and then recovery process.

$${D}_{i}^{0} ( t ) - \{ \begin{matrix}{( \frac{{N}_{repair}}{{N}_{total}} )}^{2} * {D}_{i}^{0} & t > 0 \\ 0.0001 * {D}_{i}^{0} & t = 0\end{matrix} \qquad 6$$

where Dᵢ⁰ is the expected water demand before the earthquake, Nᵣₑₚₐᵢᵣ is the number of repaired pipes at time t; Nₜₒₜₐₗ the is the total number of pipe failures due to the earthquake; t is the recovery time. t=0 indicates recovery begins. The initial post-earthquake water demand at each node is assumed to be the expected water demand (Dᵢ⁰) multiplied by a small value of 0.0001. Multiplying with a small number rather than 0 is used to avoid division by 0 when determining NSD (Eq. 8). After that, the expected water demand of each node is assumed to increase gradually with the WDN recovery process until full water demand is restored.

The real-time water supply to each node on the WDN is determined by expected water demand and the actual water pressure. The relationship between real-time water supply (Dᵢ) and the expected water demand (Dᵢ⁰) is shown in Eq. (7).

$${D}_{i} ( t ) = \{ \begin{matrix}0 & {p}_{i} < {p}_{0} \\ {{D}_{i}^{0} ( \frac{{p}_{i} - {p}_{0}}{{p}_{u} - {p}_{0}} )}^{\frac{1}{2}} & {p}_{0} \leq {p}_{i} \leq {p}_{u} \\ {D}_{i}^{0} & {p}_{i} > {p}_{u}\end{matrix} \qquad 7$$

where pᵢ is the actual water pressure at the node, the p₀ is the predefined lower bound of water pressure (under which no water is supplied); pᵤ is the upper bound of water pressure (the minimum pressure to ensure water supply to meet the design water demand)

According to Eq. (7), when the water pressure at a node is lower than p₀, no water is supplied to the node. If the water pressure at a node is higher than pᵤ, the design water demand of this node will be met. When water pressure is between p₀ and pᵤ, the real water demand is dependent upon the water pressure. p₀ and p_{f} are set as 0 and 30 meters as recommended by Zhou et. al.

The Node Satisfaction Degree (NSD) in this study is defined as the ratio between the real-time water supply and the post-earthquake expect water demand at a given time during the restoration process. NSD value larger than 1 is assumed to be 1 (or water demand at the node is fully met). The NSD is defined as follows:

$${NSD}_{i} ( t ) = \{ \begin{matrix}1 & {D}_{i} ( t ) \geq {D}_{i}^{0} ( t ) \\ \frac{{D}_{i} ( t )}{{D}_{i}^{0} ( t )} & {D}_{i} ( t ) < {D}_{i}^{0} ( t )\end{matrix} \qquad 8$$

where Dᵢ(t) is the actual water supply to the node at t; Dᵢ⁰(t) is the expected post-earthquake water demand at t. The units of both two variables are flow rate (m³/s).

Based on the NSD defined for each node, the overall degree of performance of a complete WDN are defined as the performance degree of the water network (PDW), which is calculated as the weighted sum of the NSD at each node in the WDN (Eq. (9)). The weight factor considers the relative importance of the node. Using NSD to measure the overall WDN performance allows considering the importance of critical water supply nodes by assigning appropriate weight to the nodes (i.e., Eq. (9)). For example, restoring water supply to critical facilities such as hospitals, firefighting stations, schools, etc. is more critical than less safety-critical facilities. The important nodes can be prioritized in the restoration plan by assigning proper weights to the NSD, which can be considered for the seismic consequence analysis.

$$PDW ( t ) = {\sum }_{i = 1}^{n} {w}_{i} * {NSD}_{i} ( t ) \qquad 9$$

where the wᵢ is the weight factors that consider the relative importance of the nodes; NSDᵢ(t) is the node satisfactory degree at time t which belongs to (0, 1]. The weight of a node wᵢ should be subjected to Σᵢ₌₁ⁿwᵢ=1. Therefore, the PDW at any time t falls within the range [0, 1].

As some prior studies indicated, the weight or importance of a water supply node may also change during the restoration process. A detailed method to quantify the importance of different nodes is out of the scope of this study. A pre-defined fixed weight for each water supply node is used in this paper. Dynamic changing of node importance can be considered by using the proposed framework, which is similar to the consideration of the dynamic changing of user's expected water demands.

### WDN System Resilience Measurement Based on WDN Recovery Process

Based on the definition of the time-dependent system performance degree, PWD(t), (Eq. (9)), the system resilience index (SRI) during the recovery process is defined using the area of under curve of PWD(t) (FIG. 19), i.e., Eq. (10):

$$SRI = \frac{1}{{t}_{end} - {t}_{0}} {\int }_{{t}_{0}}^{{t}_{end}} PDW ( t ) dt \qquad 10$$

where t_{end} is the time of ending recovery; t₀ is the time of beginning recovery; The integration is normalized by (t_{end}−t₀) to consider the effects of recovery time.

Based on the definition of the System Resilience Index (SRI), the larger the SRI, the faster the WDN recovers or the more resilient the WDN system is. Therefore, the objective of the optimal WDN recovery problem can be defined as finding the repairing sequence, which consists of repair actions which archives the highest SRI over the recovery process. Mathematically, the problem of optimal repair sequence can be defined in Eqs. 11 to 13. Eq. 11 defines the main objective function for optimization, which aims to maximize SRI. SRI is the resilience evaluation of the WDN recovery process, which is affected by a sequence of repairing actions aᵢ. Eq. 12 and Eq. 13 defines the constraints on the repairing actions. In this study, it is assumed that a) pipes are repaired once a time and for each time, and b) full repair of the WDN refers to the condition that the set of pipes repaired equals to the set of pipes failed. The optimization problem aims to determine an optimal repair sequence to achieve maximum SRI.

max[SRI (a₀, a₁a₂, . . . , aₙ)] 11

s.t.

a₁≠a₂≠a₃. . . ≠aₙ 12

a₁∪a₂∪a₃, . . . ∪aₙ=K 13

where SRI(⋅) is the resilience of WDN with the given repairing sequence; aᵢ is the repair action at i step; K is the set of failed pipes due to the hazards.

To focus on the key problem without loss of generality, the following assumptions are made in developing a decision support model for the optimal repair sequence to restore the WDN service.

Repair time for pipe damages: Different pipes may experience different repairing time. For example, the Federal Emergency Management Agency provided the estimated repairing time of different components. To simplify the analyses in this paper, it is assumed an equal amount of time is needed to fix any damages in a pipe. This means the repairing time for a single pipe is only determined by the total number of damages along this pipe.

Binary working status of damaged pipes: The typical pipe repairing process is normally conducted by closing the pipe end connections. A damaged pipe is re-open only when all repairs on this pipe are finished. A damaged pipe is assumed to be either closed or open based on the status of the repair. This simplifies the hydraulic model of the WDN.

Resource for repair: A single repair team is assumed, i.e., the WDN is repaired with one repairing team with no resource limits. This is also a common assumption used in prior research in determining the optimal recovery sequence of WDN (i.e., [7, 28]). This assumption ensures the failed pipes are recovered one by one.

Non preemptive recovery: It is assumed that the repairing team has to finish the repairing work on the current pipe before moving to repair the next pipe. This assumption is often used in analyzing infrastructure repair processes such as roads, bridges, and power grids, etc.

Extent of damages. There are variable extents of damages to pipes during an earthquake. To simplify the analyses, this study assumed that the leaking size is 25% of the pipe cross-section area, which is to the extent of large average damages. Similar assumption is also adopted by Shi et al.

Dynamic changing post-earthquake water demands: The water demand at each node of WDN is assumed to restore to pre-hazard condition as the restoration of WDN continues. A single post-hazard dynamic water demand process is used here. It is noted that different nodes could experience different dynamic water demand restoration process in the service WDN depending upon the function and location of the nodes. However, multiple dynamic water demand patterns can be easily added to the model when such data is available.

### A Novel Graph Convolutional Neural Network and Deep Reinforcement Learning (GCN-DRL) Machine Learning Model to Optimize Repair Sequence for WDN System Recovery

### Deep Reinforcement Learning (DRL) and Graphic Convolutional Network (GCN)

Deep reinforcement learning (DRL): DRL is an impactful development in Machine Learning (ML) model. It provides a powerful new approach to solve optimization problems based on a series of actions. DRL achieves promising results to identify the optimal action sequence from a massive set of action spaces and based on the corresponding system states and interactions with environment. Andriotis et al. provided a detailed introduction about the successful DRL applications in the management system. DRL has also been successfully applied in areas such as communications, robotics, and biology, which have proven the ability of DRL for global optimization problems with high efficiency. For the WDN restoration, the problem of optimal repair sequence is a global optimization problem. The action space is the set of damaged water pipes during earthquake. The system state is represented by the node satisfactory degree (NSD) and the WDN structure during the restoration process.

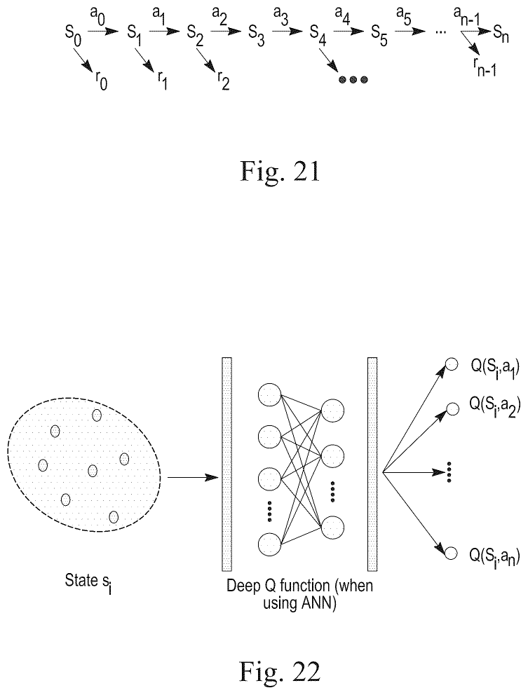

FIG. 21 illustrates an example process of reinforcement learning, namely Q-Learning, in which sᵢ∈S is the states of the system, aᵢ∈A is the space of action, rᵢ is the reward of action aᵢ when the station is DRL is one type of reinforcement learning (RL) by incorporating the technique of deep learning. As illustrated in FIG. 21, at each time step, the agent makes an action, aᵢ, from the defined action space A. This action changes the system state from sᵢ to sᵢ₊₁. In the meanwhile, the system will feedback a reward rᵢ to reward the agent based on how good this action is to positively change the system state (FIG. 21).

The RL model not only considers the instant reward of each action but also considers its potential influence in the future. Therefore, rather than choosing the action with the highest instant reward, a Q value is given to each action to determine which decision should be made. Such a Q value is defined as the Bellman equation as shown in Eq. 14. The Q value integrates the action's instant reward and the max Q value of the next state after taking this action. As demonstrated by Mnih et al., by iteratively sampling all the actions under all the states, the RL model will compile the Q values of each action under each state to get a Q table. Then, the RL model could simply determine the most optimal action by choosing the action with the highest Q value.

$$Q ( s , a ) = 𝔼 [ {\underbrace{r}}_{\begin{matrix}instant \\ reward\end{matrix}} + γ \cdot {\underbrace{arg max {Q}^{*} ( {s}^{′} , {a}^{′} )}}_{optimal future reward} ] \qquad 14$$

where the [symbol] denotes the expectation, r is the immediate reward after taking action a, and γ is the return discount for future rewards by following optimal policy of next state sᵢ₊₁.

Graph convolutional neural network (GCN): The graph convolutional neural network (GCN) was firstly proposed by Lecunn et al. as inspired by the motivation of the convolutional neural network (CNN). Graph neural network is a special neural network that can directly operate on graphic structural data. The GCN utilized the key ideas of a CNN, such as local connection, shared weights, and the use of multi-layers. It, however, convolves the neighborhoods feature to the latex space, which overcame the limitation of CNN that can only perform on regular Euclidean data such as image (2D) and text (1D). GCN has been successfully applied in domains such as physics, chemistry and biology, knowledge graph, etc. Zhou et al. provided a detailed review of the GCN and its various applications. In the civil engineering area, GCN has been applied for traffic flow prediction by treating the traffic network as a special type of graph. The successful applications of GCN in different domains have proven the potentials of GCN in understanding the complex relationships in a graph structure.

The characteristics of graphs make it adapted to describing the complex internal relationships among nodes in civil infrastructure networks. For the WDNs, the topological structure of the water pipe network can be described as a graph, with nodes represented as vertices and pipes represented as edges. The vertices and edges contain information of WDN service conditions such as the water pressure, flow rate, node connection, pipe length, and so on. Another advantage of using graph data structure for WDN is that the procedures of WDN structure and data representation can be universally applied to all types of WDN.

In this paper, the graph convolutional neural network (GCN) implemented by Kipf et al. is utilized for WDN network analysis. The layer of GCN performs a convolutional process on a graph-structured dataset. Unlike the traditional 2-dimensional convolutional process of CNN which focused on extracting the feature via a selected convolution filter, the GCN layer conducts the feature extraction of each vertex and its neighbors. Therefore, the structure of the graph is considered. Mathematically, a graph convolutional layer in GCN will project the nodes of the WDN network into a latex space by using Eq. 16.

$${H}^{l + 1} = σ ( {\tilde{D}}^{- \frac{1}{2}} \tilde{A} {\tilde{D}}^{- \frac{1}{2}} {H}^{l} {W}^{l} ) \qquad 15$$

where
H^{l} is input to the l^{th} layer of GCN neural network. At the input layer l=0, H⁰=X. where X is the feature matrix of the graph whose dimension is N×D, N is the number of nodes, D is the number of features of each node;
À=A+I, where A is the representative description of the graph structure. An adjacency matrix is used in this study to describe the graph structure. I is the identity matrix with the same dimension as A;
\tilde{D} is the diagonal node degree matrix of À;
σ(⋅) denotes the activation function. The commonly used Relu activation function is used in this study;
W^{l} is the weight matrix of the l^{th} layer.

The input to the GCN is the feature matrix of the graph, X, whose dimension is N×D, N is the number of nodes, D is the number of features of each node. In this study, one feature is used for node attribute which is the node satisfactory degree (NSD) defined in Eq. 8. The output of each GCN layer is N×P, where P is the predefined dimension of latex space.

### GCN-DRL Hybrid ML Model for Optimal WDN Recovery

A hybrid ML model is proposed in this study to optimize WDN recovery by combining the GCN and DRL. This study is the first attempt to utilize Graph Convolutional Network (GCN) to extract information from the graph structure and analyze the water distribution network recovery.

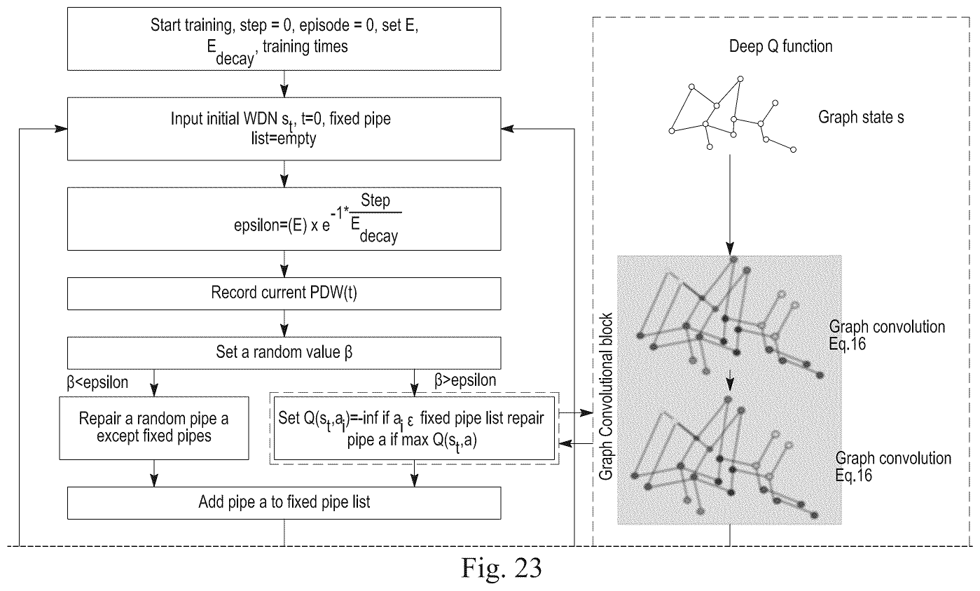

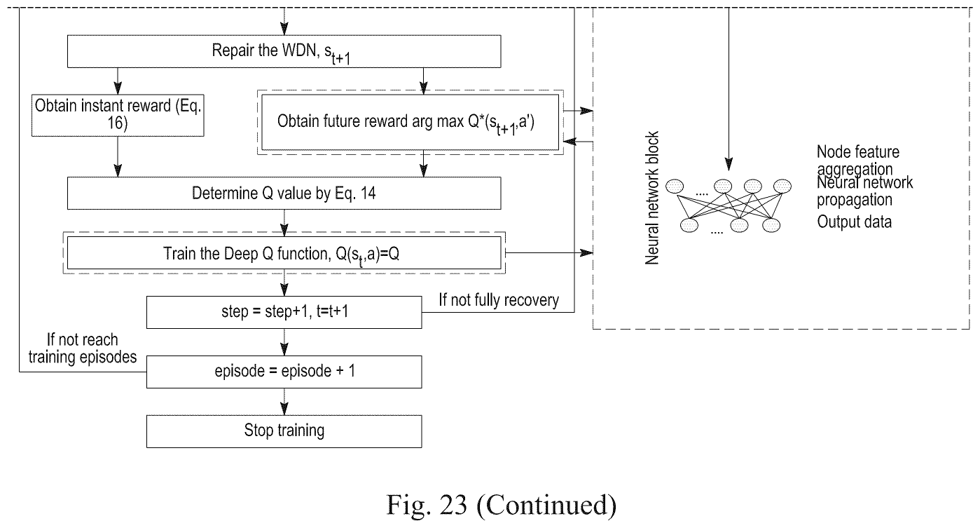

An architecture of the proposed GCN-DRL Hybrid ML model (short as GCN-DRL), which can be used by the systems and methods described herein, is shown in FIG. 23. The left side of FIG. 23 illustrates the reinforcement learning framework (DRL) to train the deep Q function and the right side of FIG. 23 provides the architecture of the deep Q function based on GCN. At the training stage, the initial state (sₜ₌₀) of WDN is represented by the current node satisfactory degree (NSD) and the network structure. The repair decision based on the current state is determined by either ‘random selecting’ or ‘deep Q function’. The benefit of taking random actions is that this process could prevent the agent from trapping in local optimization especially when its experience is limited. A fixed pipe list is recoded to prevent any pipes from being repaired repeatedly. If the new action is chosen randomly, it is chosen from the remaining failure pipes. When the new action is determined by the deep Q function, the Q values of fixed pipes are set as negative infinity. Then, the attribute of the nodes in the network is updated by conducting recovery procedure (right side of FIG. 20), which is used to represent the next states sₜ₊₁. Two reward values are essential to determine the Q value of the adopted repairing decision, i.e., instant reward function and future reward function (Eq. 14). The instant reward is proportional to the improvement in the performance degree of WDN (PDW) with the consideration of repairing time (Eq. 16). The future reward is obtained by feeding the updated state of WDN into the deep Q function and get the maximum output. Then, the deep Q function is trained by the current state sₜ, taking action a, and corresponding Q value Q(sₜ, a).

$$r = \frac{{PDW}_{i} ( t ) - PDW ( t - 1 )}{{T}_{i}} \qquad 16$$

where PDWᵢ(t) is the degree of performance of WDN after taking repair action i; PDW(t−1) is the degree of performance of WDN after previous repair action; Tᵢ is the duration of repairing pipe i. This study assumes the repairing time is determined by the number of damages of the fixed pipe.

The deep Q function which integrates the deep GCN is shown on the right side of FIG. 23. The graph of WDN with nodes attribute (NSD in this study) is used as the input. It is projected by the first layer of graph convolution with 64 dimensions. The outputs are then projected to 128 dimensions by the second GCN layer. The output of the 2^{nd} GCN layer is aggregated by taking the average values of the projected mode attribute in each dimension, which is 128 dimensions as well. The aggregated data is fed into a neural network. The first layer of the neural network contains 128 neurons to accept the input data with 128 dimensions. The number of neurons in the second or output layer of the neural network equals the dimension of action space, which is the total number of damaged pipes in this case. A linear activation function is used in the neural network.

However, for most real-world problems, the aforementioned Q table is extremely hard to obtain due to the infinity number of combinations of s and a. To overcome this challenge, DRL is proposed. The DRL intends to leverage the advancement in deep learning to solve the traditional RL problem, which contains a large set of status space and an action space. Rather than using a Q table, a deep Q function is utilized to estimate the Q value of each action under different states, as shown in FIG. 22, which illustrates concept of DRL that use Artificial Neural Network (ANN) as the deep Q function. Classical DRL typically uses common types of artificial neural networks such as the artificial neural network (ANN) as the Deep Q function, which cannot encode the structural relationship of networked infrastructure. To further advance this domain, a novel graph convolutional neural network (GCN) is incorporated in this study to be the Deep Q function to account for the special network structure of WDN and corresponding data type.

The proposed GCN-DRL Hybrid ML model is used to determine the pipe repair sequence. To achieve a smooth and stable training result, the technique ‘Experience replay’ described by Mnih et al. is also used in this study. The graph neural network and reinforcement learning used in this study is performed by the python deep graph library and PyTorch library.

### Case Study

### Case Study Rancho Solano Zone III WDN

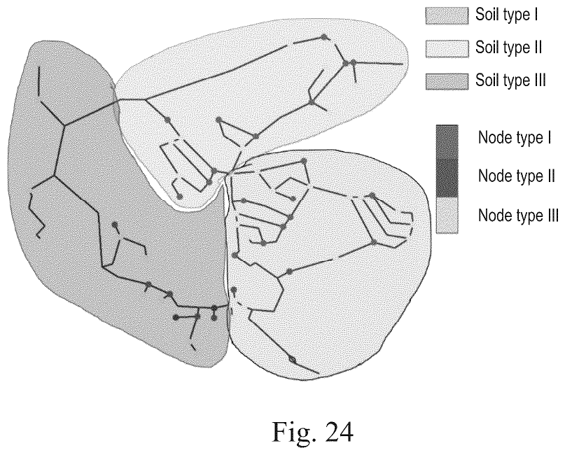

The GCN-DRL based repair decision-making model based on the recovery-based WDN seismic resilience evaluation framework is applied to analyze the seismic recovery of a testbed WDN located in Fairfield, California. The complete dataset about this WDN is publicly available from the database maintained by the University of Kentucky. The original water demand and water supply conditions are used in the study. The influence of pipe ages, materials, costumer importance, and soil types is also considered in this case. The detailed information about the testbed is summarized in Table 3. FIG. 24 illustrates the WDN structure, the levels of node importance, and the soil types.

TABLE 3
Information summary of the testbed

| | Variable name | Value | Description |
|---|---|---|---|
| WDN | Pipe numbers | 126 | Total number of edges |
| structure | Node numbers | 112 | Total number of vertices |
| | Node sea level | [90, 139] | This is predefined by the |
| | (meter) | | dataset |
| Pipes | Pipe length | [90, 120] | This is predefined by the |
| | (meter) | | dataset |
| | Pipe age (years) | [50, 100] | Randomly assigned to each |
| | | | pipe based on uniform |
| | | | distribution |
| | Pipe material | ‘Cast Iron’, | Randomly assigned to each |
| | | ‘Ductile Iron’, | pipe. |
| | | ‘Steel’, | |
| | | ‘PVC’, | |
| | | ‘Asbestos' | |
| Customers | Customer | 63 | Vertices whose basic water |
| | numbers | | demand is larger than 0. |
| | Weights of | I: ω = 5 | Different types of customers. I |
| | customers | II: ω = 3 | denotes the most important |
| | (unitless) | III: ω = 2 | node and III denotes the least |
| | | | important. |
| Soil | Soil type | I: Rₛₒᵢₗ < 1500 Ω | Different types of soil, Rₛₒᵢₗ |
| | | II: 1500 Ω < | denotes the soil electrical |
| | | Rₛₒᵢₗ < 2000 Ω | resistivity. Defined in FIG. 24 |
| | | III: Rₛₒᵢₗ > 2000 Ω | |

### Water Pipes Seismic Failure Prediction and GCN-DRL Hybrid Model Training

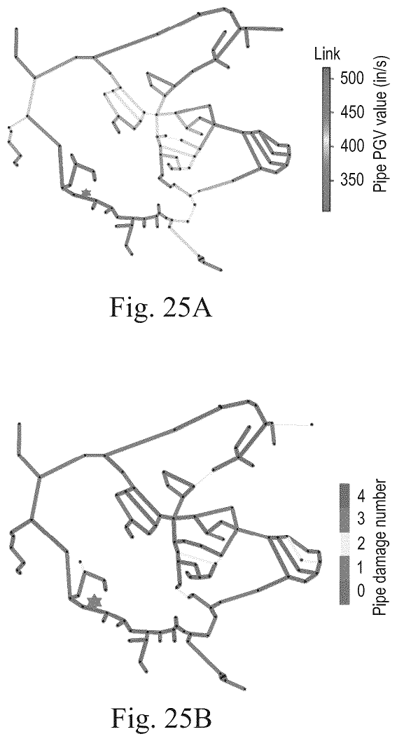

FIGS. 25A and 25B illustrate distribution of PGV along the pipelines and distribution of damaged pipes with the number of damages indicated. The WDN is assumed to be subjected to a magnitude VIII earthquake with the epicenter located at the left bottom of the WDN (e.g., show as a star annotated in FIGS. 25A and 25B). The depth of the earthquake is assumed to be 5 km. The earthquake-induced Peak Ground Velocity (PGV) is calculated using Eq. (4) and shown in FIG. 25A. The corresponding numbers of pipe damages are determined considering the influences of pipe material, pipe age, pipe length, and soil material based on the equations described in the earlier context (Eq. (1) to Eq. (5)). The predicted number of damages on each pipe is shown in FIG. 25B. Overall, the earthquake causes 69 total damages along 44 pipes. The initial performance degree of the WDN (PDW) immediately after the earthquake is computed to be about 0.00564.

The proposed GCN-DRL model is trained to repair the damaged pipes in the WDN. Table 2 shows the key parameters used in training the GCN-DRL mode. The training episode is set as 500. Since 44 pipes are damage, this means the deep Q function is trained 22,000 times. The parameter epsilon, which determines if repair is by random decision or by RL learning, started with 1 and continues to decrease to a small value with progresses in WDN repairment. The E_{decay} is set as 5000 so the epsilon value could be nearly 0 at the end of training (0.0122).

TABLE 4
Key parameters used for the GCN-DRL model

| Parameter | Description | value |
|---|---|---|
| epsilon | The parameter used to control action taken randomly or GCN based | $epsilon = E \times {e}^{1 \times \begin{matrix}step \\ {E}_{decay}\end{matrix}}$ |
| E | The initial value of epsilon | 1 |
| E_{decay} | Control the epsilon decreasing speed during the | 5000 |
| | training process | |
| training episode | Total episode number for the training. 1 | 500 |
| | episode means one completely recovery | |
| | process | |

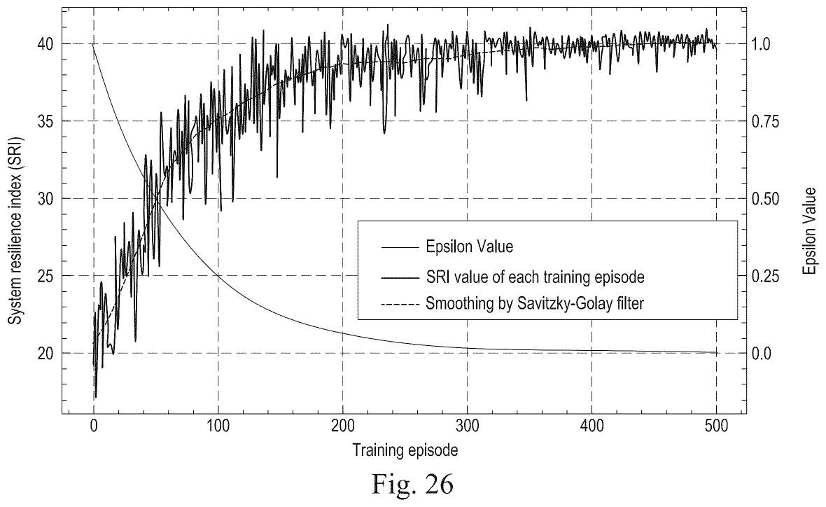

FIG. 26 is a graph showing the learning curve for the methods described herein. FIG. 26 shows the SRI of the WDN system under 500 training episodes and the corresponding epsilon values. The smoothing SRI is derived from Savitzky-Golay filter as shown by the increasing curve superimposed the SRI values. The control parameter ‘epsilon’ determines if the repair decision is made randomly (large epsilon) or from deep Q function (small epsilon). The results imply that the SRI values in the first 70 episodes are relatively low and unstable since the control parameter ‘epsilon’ is relatively large, these restoration actions are mainly randomly chosen (FIG. 23). As the training process continues, the control parameter ‘epsilon’ decreases so the probability of taking actions guided by GCN increases. The agent makes decisions mostly based on the GCN after around 350 episodes and stable solutions are observed with high SRI values. The fluctuations of the SRI are due to the inherent randomness within the neural networks and high dimensional status space.

### Conventional Decision-Making Methods for Pipe Repair

The performance of the repair sequence by developed GCN-DRL ML model is compared with conventional decision-making methods. Four conventional decision-making methods for WDN repair sequence, i.e., static importance-based method (S2), dynamic importance-based method (S3), genetic algorithm-based method (S4), and random repairing method (S5) are chosen as comparison basis under the same damage scenario (FIG. 25B)). The mechanisms of these conventional methods (named as S2 to S5) are briefly described as following:

S2: static importance-based method. This method prioritizes pipe repair based on ranking the improvements of the WDN performance degree (PDW) after repairing the pipe over the initial damaged status. The larger the ranking factor, the higher the priority the pipe to be fixed. The ranking factor of pipe i is defined as:

$${I}_{s , i} = \frac{{PDW}_{i} - {PDW}_{0}}{{T}_{i}} \qquad 17$$

where PDWᵢ is the performance degree of WDN after repairing pipe i; PDW₀ is the performance degree of WDN before any recovery; Tᵢ is the repairing time for pipe i, which equals the number of damages on the pipe.

S3: dynamic importance-based method. This method determines the pipe repair priority by the dynamic importance during the recovery of the WDN. Unlike S2 which only compares the performance improvement with the initial damage status, S3 compares the performance between the pipe recovery and current WDN status by the following equation. The importance of pipe i is ranked based on I_{d,i}(t),

$${I}_{d , i} ( t ) = \frac{{PDW}_{i} ( t ) - PDW ( t - 1 )}{{T}_{i}} \qquad 18$$

where PDWᵢ(t) is the performance degree of WDN at time t after repairing pipe i; PDW(t−1) is the performance degree of WDN before at the last time step; Tᵢ is the repairing time for pipe i, which equals its damage number.

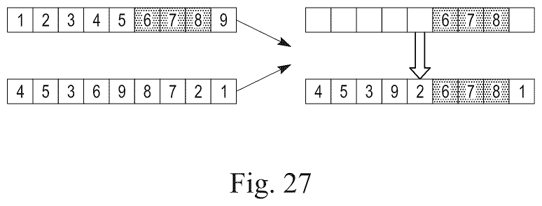

S4 Genetic algorithm-based method. Genetic Algorithm (GA) is a widely used global optimization algorithm. As a combinatorial optimization problem, special crossover and mutation methods are adopted in this study. The application of GA in this paper is summarized as follows.
1) Initial population. Considering there are 44 pipes failure after the seismic, the total combination of repairing sequence is 441=2.558e^{S4}. 50 different sequences out of these possible combinations are set as the initial population.
2) Population evaluation and ranking. The SRI values using these 50 different sequences are calculated and ranked.
3) Parents selection. The elitism principle and fitness priority principle are both followed for parent selection. For the elitism principle, the elite number is set as 3, or the top 3 performance parents will be always selected. For the remaining parents, the individual achieving a higher SRI value will have a higher probability to be selected.
4) Crossover and mutation. FIG. 27 illustrates an example of crossover for a genetic-based algorithm method. Ordered crossover is used for parent crossover, as shown in FIG. 27. Firstly, a random subset of parent 1 is selected and filled into the sequence in parent 2. The mutation of each individual is performed by randomly exchange two genes with a very low probability. In this study, this probability is set as 0.03.
5) Repeat. After crossover and mutation, the new generation of the population will be obtained. These new samples will be calculated and ranked by the corresponding SRI values. The total number of generations in this study is set as 200.

S5 random repairing method. This method chooses a random repairing sequence.

### Evaluation of Computing Performance

The computing performance of each method is evaluated by the final SRI value of the recovery trajectory, the recovery time to achieve satisfactory level of system performance, and the computational time.

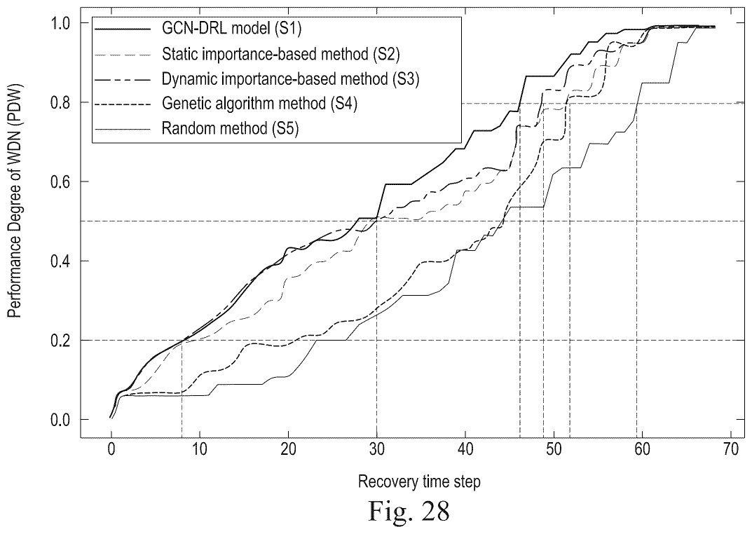

Examples of recovery trajectories by using methods from S1 to S5 are shown in FIG. 28, and the corresponding SRI values are summarized in Table 3. Compared with conventional methods (S2 to S5), the proposed GCN-DRL method (S1) significantly improves the area under the trajectory curve, which corresponds to a higher system resilience index (SRI) value. It is noted that GA-based method (S4) is a global optimization method. The under curve area of recovery process by GCN-DRL (S1) is much larger than that by GA method (S4), which indicates the GCN-DRL outperform GA as a global optimization method for repair sequence.

The recovery time to achieve a minimal satisfactory level of system performance is critical for infrastructure restoration. FIG. 28 also shows the recovery time to achieve certain performance levels of WDN based on repair sequences by different decision methods. The results imply that the repair sequences by S1, S2, and S3 achieved 20% and 50% performance degrees in a similar amount of time. After that, the repair sequence by the GCN-DRL (S1) method ensures the fastest recovery until the system is completely restored. The observations are attributed to that the developed GCN-DRL model (S1) can efficiently consider the future impact of repair decisions compared to the local optimization methods (S1 and S3) and therefore achieve a global optimal repairing sequence. The performance of genetic algorithm (S4) lagged until the system recovers to about 95% of its original performance. Assuming 80% system performance is a minimal satisfactory level. The proposed method (S1) achieved around 2 time steps ahead of S3 and around 5 time steps ahead of genetic algorithms (S4). These demonstrates the superior performance of the GCN-DRL model in determining the optimal repair sequence compared to conventional optimization algorithms.

The computational time to determine the repair sequence by methods S1 to S5 are compared in Table 3. The GCN-DRL ML model takes more computational time than S2, S3, and S5 since a large number of training iterations are involved. For example, in this case, the GCN-DRL model takes 500 training episodes, each training episode contains 44 times of repairing process (44 damaged pipes). Therefore, 22,000 hydraulic simulations were conducted to capture the WDN performance The deep Q function was also trained 22,000 times. However, it is noted that the computational time is based on a model that is trained from scratch. The trained GCN-DRL model can be utilized by transfer learning, which can significantly reduce the computational time needed to generate decisions when new disasters occur.

TABLE 5
SRI and computing time among different recovery methods

| Method | S1 | S2 | S3 | S4 | S5 |
|---|---|---|---|---|---|
| SRI | 41.67 | 36.977 | 39.225 | 30.868 | 26.538 |
| Time | 2.3 h | 3 min | 15 min | 3.2 h | 2 min |

### Rapid Determination of Optimal Repair Sequence by Transfer Learning of Prior Experience

Traditional resilience-oriented methods have to start from scratch for each new failure situations, which compromises its computational efficiency. Quick response to damages by different new disasters are desirable to decrease the economic loss and benefit global restoration plan. While the GCN-DRL achieved decision sequence that ensures fast system recovery, training the model from scratch requires relatively long computational time. To reduce the computational time, a novel transfer learning strategy is explored for the GCN-DRL for new disaster scenarios. That is, when training the GCN-DRL model, the parameters of the deep Q function such as the neuron weights and biases can be saved as the ‘training experience’. Hence, unlike conventional decision algorithms that need to start from scratch for each damage scenarios, the GCN-DRL model can use the ‘training experience’ from previous training result as long as the new damaged pipes have been considered. Consequently, a high computational efficiency is achieved, which is advantageous especially for a long-term management strategy.

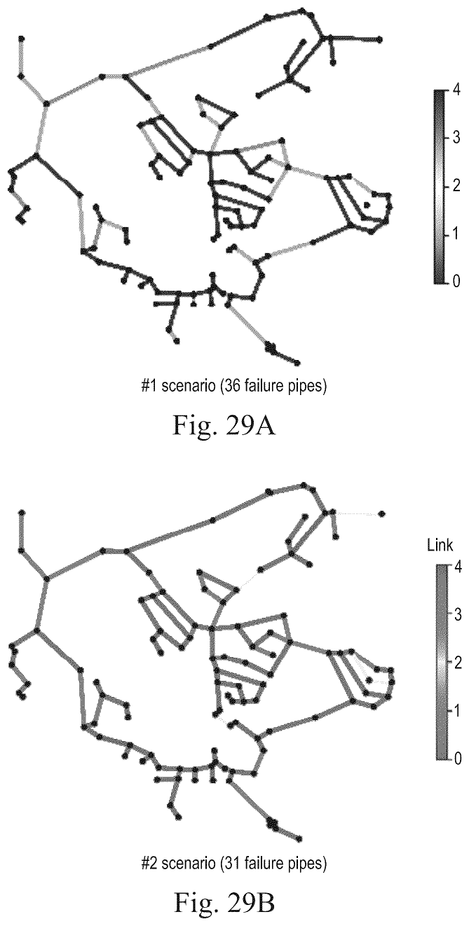

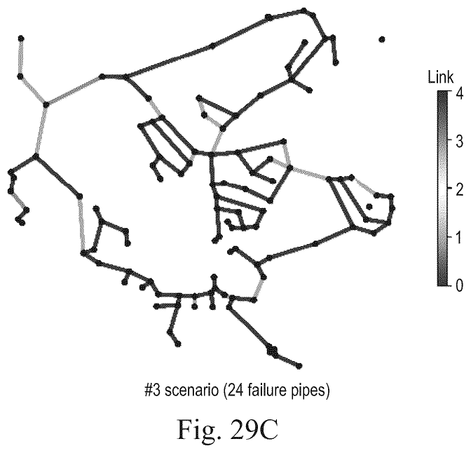

To demonstrate the benefits of transfer learning, the performance of the GCN-DRL model and computational time based on transfer learning for new damage scenarios is compared with those by conventional methods. The new damages are randomly chosen from a subset of the predicted pipe damages (FIG. 24B)) as the initial damage situation. FIG. 29 shows the selected damage situations with 36, 31, and 24 failure pipes respectively. The ‘training experience’ that trained in the section entitled Water pipes seismic failure prediction and GCN-DRL Hybrid model training is loaded by the GCN-DRL model (S1). Methods S2, S3, S3, and S5 are used for comparison purposes. The pre-trained GCN-DRL was trained with 10 episodes for each new WDN damage situation.

Table 5 summarizes the performance as well as the corresponding computational time to determine the repair sequence by different methods on the new damage scenarios.

In terms of performance in ensuring WDN system resilience, the GCN-DRL model (S1) with transfer learning achieved the highest SRI value among all the methods. The SRI value of the repair sequence by S1 is larger by 1.16, 0.252, 1.706, and 8.911 than that of the rest four repair methods respectively under the situation of 36 damages. The SRI value based on repair decision by S1 only improved 0.034, 0.003, 1.386, and 9.939 for the scenario with 24 damaged pipes. The comparison indicates that the larger the number of pipe damaged, the more advantages of GCN-DRL in achieving an optimal decision sequence than conventional methods. This is reasonable since the larger the number of pipes damaged, the more difficult it takes to identify the global optimal with conventional methods. This is an indication of the powerfulness of GCN-DRL model in making global optimal decisions among a large decision space.

In terms of the computational time for decisions, the use of transfer learning significantly reduced the time needed for the GCN-DRL model to determine the optimal repair sequence. The computational time is comparable to those needed by conventional methods. It is noted that the GCN-DRL model significantly outperformed the GA method, a global optimization method, in terms of both performance and computational efficiency.

TABLE 6
Summary of SRI of WDN recovery based on repair sequence
by different methods as well as the corresponding
computational time for different damage scenarios

| Scenario | Performance | Method | | | | |
|---|---|---|---|---|---|---|
| No. | indicator | S1 | S2 | S3 | S4 | S5 |
| 1 (36 | SRI | 35.449 | 34.286 | 35.197 | 33.743 | 26.538 |
| failures) | Time | 6 min | 3 min | 15 min | 4.0 h | 1 min |
| 2 (31 | SRI | 33.243 | 31.746 | 32.414 | 29.674 | 17.762 |
| failures) | Time | 5 min | 4 min | 11 min | 2.6 h | 1 min |
| 3 (24 | SRI | 27.551 | 27.517 | 27.548 | 26.165 | 17.612 |
| failures) | Time | 4 min | 4 min | 10 min | 2.1 h | 1 min |

### Conclusions

Optimal repair decisions play an important role in improving WDN resilience by accelerating post-disasters recovery. To improve system resilience by optimizing the repairing decisions, this study proposed a WDN seismic resilience evaluation framework and a novel decision-making model for resilience-oriented restoration plan. The resilience evaluation framework consists of a model for pipe failure prediction, a model for WDN performance measurement, and a model for WDN resilience quantification. The system resilience index (SRI) is proposed for the system resilience quantification, which is defined on the time evolution of WDN system performance degree (PDW) during the recovery process. The PDW considers the node satisfaction degrees (NSDs), which measure the extent of the dynamic water demands post-hazards at nodes of the WDN are met, weighted by the relative importance of the nodes. With the system resilience indicator SRI, a novel Graph Convolutional Network (GCN) and Deep Reinforcement Learning (DRL) hybrid machine learning model is developed to determine the optimal repairing decision. The GCN-DRL model combines the advantages of DRL and GCN. The GCN is used to embed the WDN including the topological connections and information of each node. The DRL framework is used to train the GCN to determine the optimal repair actions under any given damage situations.

The GCN-DRL model is demonstrated to determine the optimal repair sequence of a testbed WDN subjected to earthquake damages. The damage scenarios are determined with considerations of the magnitude of the earthquake, distance to the epicenter, soil type, pipe deterioration, etc. The performance of the pipe repair sequence by the GCN-DRL model is compared with the results by four traditional decision-making methods. The results show that the GCN-DRL model consistently achieves repairing sequences that lead to highest system resilience index (SRI) under different damage scenarios. Besides, transfer learning strategy can be used to train the GCN-DRL model for new damage scenarios by taking the advantage of the previous training experience, which significantly improved the computational efficiency. The transfer learning strategy was demonstrated on three new damage situations of the WDN. The results show that the transfer learning of GCN-DRL decision making model achieved the most resilient WDN recovery with significantly reduced computational time. Therefore, the new GCN-DRL model is promising to be a high-performance robust decision-support tool for post-hazard repairing decisions to ensure resilient WDN recovery.

### AI-EMPOWERED INTELLIGENT WATER LEAK DETECTION SYSTEM

### Overview

The following portion of this description aims to fully leverage the potential of real-time data acquisition systems combined with advanced machine learning (ML) to achieve high sensitivity, accuracy, speed, and reliability in detecting the leaks in the water systems. A user-friendly water system monitoring application seamlessly integrates hydraulic simulation, pressure monitoring, and AI-empowered leak detection.

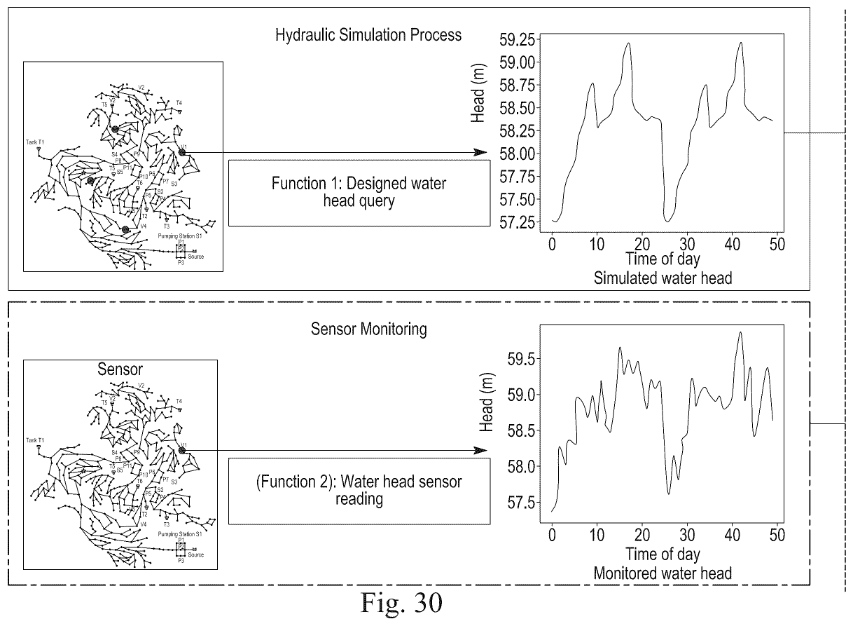

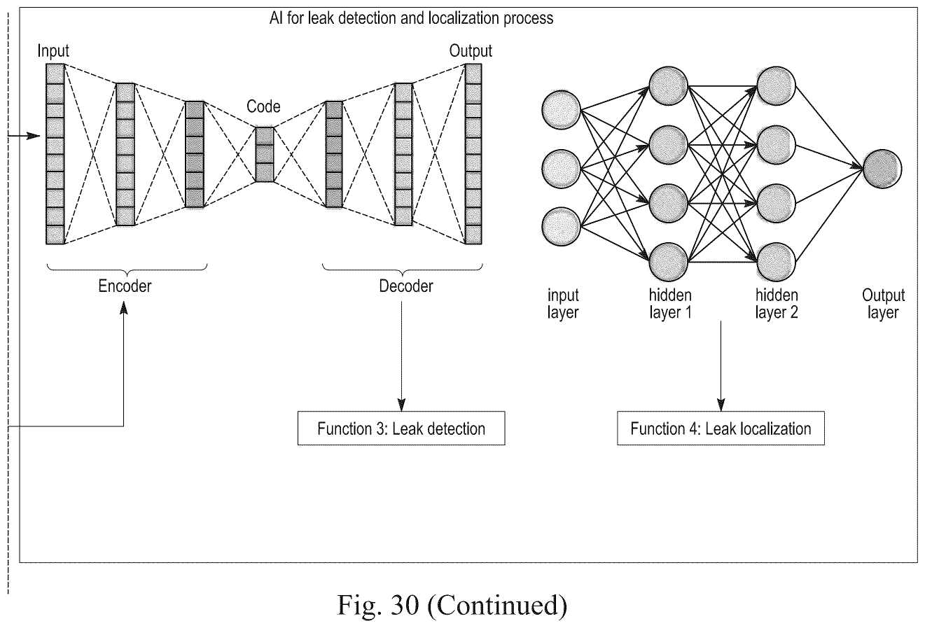

FIG. 30 illustrates the flowchart depicting the key functions of the AI-based leak detection system. As illustrated in FIG. 30, the system acquires and manages the hydraulic information from both hydraulic simulation and real-time sensor monitoring data by the SCADA. Enabling to generate and update leak data, optimize sensor placements, and effectively train the AI models. The system provides a novel clustering algorithm to recommend the optimal locations for sensor placements, which provides a cost effective way to monitor the whole water system with minimum number of sensors (i.e., the deployment of sensor to cover the water system as denoted by the red dots). Data for AI model training leverages both the simulation data and real time sensor data. The hydraulic model is based on EPANET which is used to generate different scenarios, including different leak scenarios and normal service scenario (details of the hydraulic simulator and leakage simulation is described below in subsection entitled Technomics Analyses). A novel cluster algorithm considering WSN topology and hydraulic similarities is used to determine optimization of sensor placements (details elaborated in section entitled AI-algorithm for optimal sensor placement). The AI model and training processes are described in sections entitled AI Model for Intelligent Sensor Placement and Leak detection.

### Generality and Extensibility

Our application design incorporates generality and extensibility in mind, that allows to incorporate further development of leak detection technology and to allow it to be easily adapted to different water systems.

As an example, lack of real-world sensing data put a constraints on the AI model training, however, systems and methods described herein, which incorporate both simulated data and real-time monitoring data, are fully prepared for inclusion of more labeled leak data in the future. The robustness and accuracy of the AI-application is ready to embrace more real-world data collected by sensor deployment. This will further enhance the accuracy and efficacy of this AI-based leak detection methodology.

The strong generality of the systems and methods described herein allows them to be deployed to various water utilities. It is hoped that systems and methods described herein can equip water utilities with a state-of-the-art tool that empowers them to proactively detect and timely address leaks related asset management issues. By integrating the potential of real-time data and cutting-edge AI, the systems and methods described herein aim to enhance the resilience and efficiency of water supply networks, ensuring a sustainable and reliable water distribution system for communities.

### Application Interface

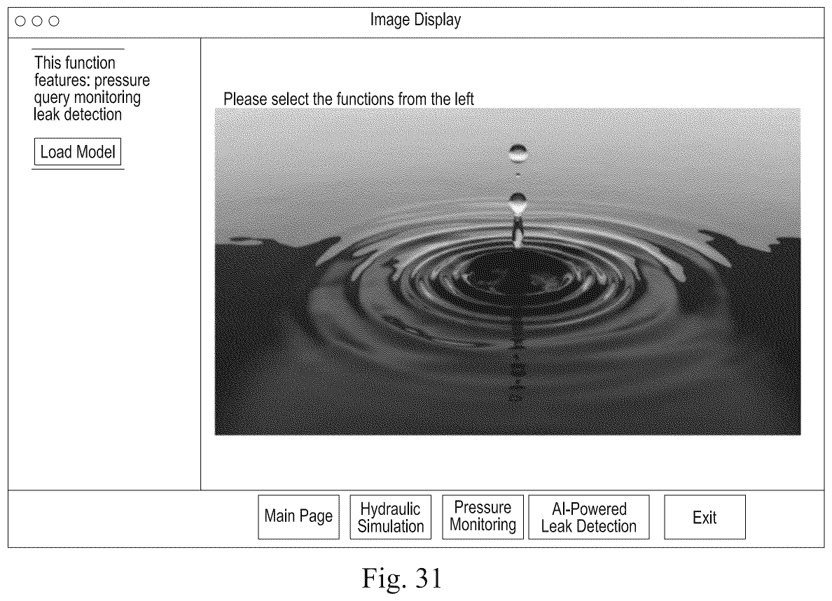

FIG. 31 illustrates an example welcome page of the intelligent leak detection application. The user interface for the intelligent leak detection is designed to provide users with a seamless experience. Different water utilities can easily upload their hydraulic models in the widely recognized standard ‘inp’ file format, compatible with the EPANET simulation package.

The welcome page also includes three important functions that cater to the needs of water system management, including hydraulic simulation, pressure monitoring, and leak detection, making it a comprehensive solution for hydraulic system analysis.

The remaining documents are organized according to the major functions of the application, which include the hydraulic simulation function for WSN, the works that has been made for a real-time water pressure monitoring, details of the AI-empowered water leak detection and localization, and technomics analyses.

### Hydraulic Simulation and Pressure Query

### Interface of Hydraulic Simulation

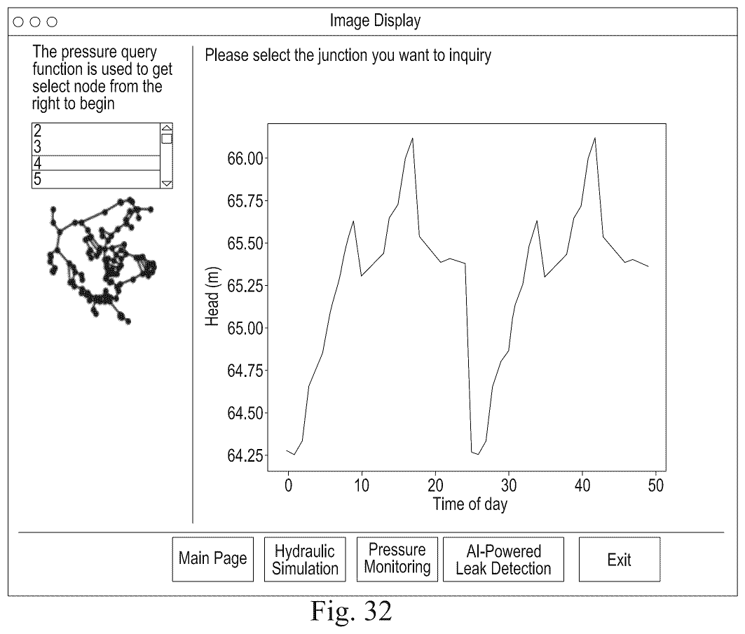

FIG. 32 shows an example interface of the hydraulic simulation and query function. The interface of FIG. 32 allows to load any WSN based on EPANET input format. Other formats can also be used. The hydraulic simulation is conducted every time when a new hydraulic model is uploaded or modified. The simulation time step is dependent on the settings defined in the hydraulic model. The user interface also includes a water pressure inquiry function, where the user can select to display the water head variations at any nodes in the WSN, such as shown in FIG. 32.

### Hydraulic Model

A hydraulic model is commonly used to compute the hydraulic parameters such as water pressure or water head and flow rate for the design of a water distribution network. The governing hydraulic equations describe the conservation of mass and conservation of energy considering the topological characteristics of a water pipe network. The hydraulic model allows to account for the water usage behaviors (described as water demand fluctuations at the service nodes) and events such as leakages on the network performance While hydraulic model is regarded as sufficiently accurate for water network planning purpose, there are uncertainties of the model prediction results due to fluctuating water demands, deteriorating pipe conditions, etc. A calibrated hydraulic model serves as the basis for model-based leak detection. Given it is sufficiently reliable, hydraulic model can be utilized to generate holistic artificial datasets for the development and validation of ML-based leak detection algorithms As a general note, using holistic artificially generated data is a common strategy in the development of ML technologies when data is not available due to practice constraint. The key equations used for the hydraulic computations are introduced in following.

Equation (1) of the hydraulic model describes the conversation of mass at a pipe node, which prescribes that under no leak condition the inflow of water to a pipe node equals to the outflow of water. The outflow of the water including the demand or use of water at that node as well as water flowing from this node to other nodes.

$${\sum }_{p ∈ {P}_{n}} {q}_{p , n} - {D}_{n}^{act} = 0 , ∀ n ∈ N \qquad ( 1 )$$

where Pₙ is the set of pipes connected to the node n, q_{p,n} is the flow rate of water into node n from pipe p (m³/s), Dₙ^{act} is the actual water demand at node n (m³/s), and N is the set of all nodes in the pipe network. q_{p,n} is positive when water is flowing into node n from pipe p, otherwise, it is negative.

Equation (2) of the hydraulic model describes the conversation of energy. For water pipe network, the total energy is typically referred as the total water head, which includes components describing the kinetic energy (kinetic water head), hydraulic potential energy (pressure head), and gravitational potential energy (elevation head), i.e.,

$${h}_{A} = \frac{ι {ι}_{A}^{2}}{2 g} + \frac{{p}_{A}}{{r}_{w}} + {z}_{A} = {h}_{B} + {H}_{L} = \frac{ι {ι}_{B}^{2}}{2 g} + \frac{{p}_{B}}{{r}_{w}} + {z}_{B} + {H}_{L} \qquad ( 2 )$$

where h is the total water head , u is the water velocity at each node, and z is the altitude of each node. H_{L} is the energy loss between node A and node B. There are two major mechanisms for the energy lose in a pipe flow, i.e., the distributed energy loss and localized energy loss. The distributed energy loss along the pipe due to hydraulic resistance is mainly determined by the velocity of the flow V, the internal diameter of the pipe d, the length of the pipe L, and the roughness of the pipe wall, which is described by the Hazen-Williams formula [33], i.e., Equation (3).

$$H ( m ) = ( \frac{6.78 L}{{d}^{1.165}} ) ) {( V / C )}^{1.85} \qquad ( 3 )$$

where C is the roughness coefficient of pipe wall.

The localized energy loss is due to turbulence associated with change of flow conditions (such as flow speed, direction, or flow area etc.), which is determined by the topology of water distribution network connections.

An important phenomenon in a water supply network is the water usage or demand. Two major types of models are generally used for water demand at pipe nodes, i.e., demand-driven model and pressure-driven model. A comparison of both models is described in [34]. A pressure-driven water demand model is used in this study to consider the effects of losing pressure due to change of water demand or leaks.

$$D = \{ \begin{matrix}0 & p \leq {P}_{0} \\ {{D}_{f} ( \frac{p - {P}_{0}}{{P}_{f} - {P}_{0}} )}^{\frac{1}{2}} & {P}_{0} \leq p \leq {P}_{f} \\ {D}_{f} & p \leq {P}_{f}\end{matrix} \qquad ( 4 )$$

where D is the demand at a particular node, D_{f} is the desired demand(m³/s), p is the water pressure, P_{f} is the pressure above which the desired demand D_{f} should be met, P₀ is the water pressure below which no water will be supplied at the node. The leaking is modeled as a special type of water demand in this study. The demand due to a leaking scenario is related to the size of the leak and is described in Equation (5) [35].

$${d}_{leak} = {C}_{d} {Ap}^{\partial } \sqrt{\frac{2}{ρ}} \qquad ( 5 )$$

where dₗₑₐₖ is the equivalent water demand due to leak (m³/s), C_{d} is the discharge coefficient, with a default value 0.75, A is the area of leak, p is the internal water pressure, the exponential ∂ is the discharge coefficient, which is 0.5 for steel pipe, and ρ is water density.

### Management of Monitoring Sensor

### AI-Algorithm for Optimal Sensor Placement

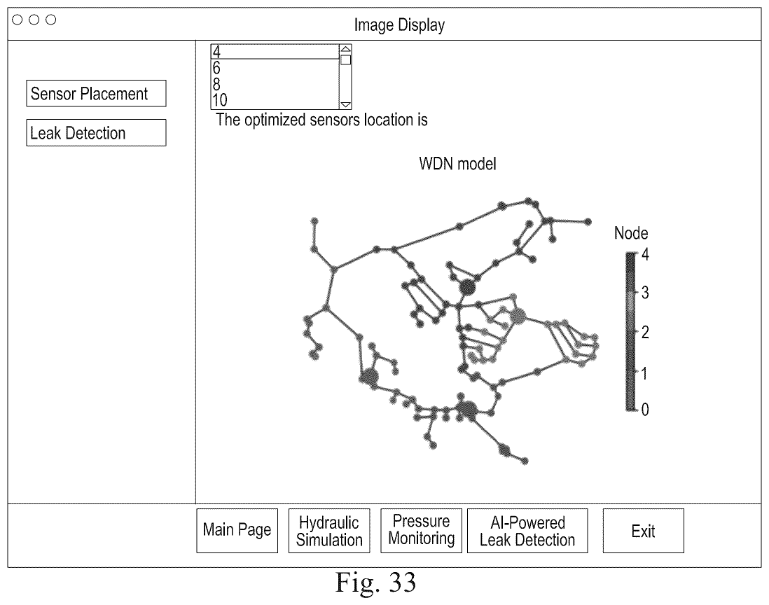

FIG. 33 illustrates an example interface for determination of the optimal sensor placement and clusters. The interface of FIG. 33, is configured to determine optimal sensor placement. This user-friendly interface allows users to customize the number of sensors they wish to utilize. The optimized sensor locations are visually represented by larger nodes, each distinguished by different colors. For instance, in FIG. 33 demonstrates an example system equipped with 4 sensors, and their strategically placed locations to achieve the maximum value of sensor data collection. In addition to identifying the best sensor positions, the sensor optimization algorithm automatically groups the system into various clusters, each denoted by a unique color. These groups play a crucial role in leak localization algorithms, as they aid in narrowing down the potential leak areas. Detailed algorithms about the sensor optimization process are expanded in the subsequent paragraphs.

### Modified k-Means Algorithm for Sensor's Optimal Placement

A modified k-means clustering algorithm has been configured for WDN partition. Compared to the standard k-means WDN clustering which only considers the leakage characteristics of junctions, the new algorithm also considers the topology of the WSN (via the shortest physical path distance between junctions over the WDN). The pseudocode of the new k-means clustering algorithm is shown in the following Table 7.

TABLE 7
New k-means cluster algorithm for WDN
partition and optimal sensor placement

Algorithm: Modified k-means algorithm for WDN sensor placement
step 1: Initialize parameters: set the number of cluster k, tolerance,
maximum iteration number
step 2: Randomly select k junctions from the WDN as the first group of
centroids.
step 3: Data preparation
step 3.1: Prepare the leakage characteristics matrix.

| | |
|---|---|
| • | I.a) For the conventional leakage characteristics matrix, use |
| | Table 1. |
| • | I.b) For PCA- or AE- based leakage characteristics matrix, |
| | follow Figs 2 and 3 respectively. |
| • | II. Normalize the leakage characteristics matrix by dividing its |
| | maximum value. |

```
  step 3.2: Calculate the WDN physical pair distance matrix by
  computing the shortest path between all junctions. Standardize the
  matrix by dividing its maximum value.
step 4: Calculate the total Euclid distance between junctions
  step 4.1: Calculate the junctions' Euclid distance matrix measured by
  the junction leakage characteristics matrix pairs, L_{leakage}
  step 4.2: Calculate the component of Euclid distance matrix measured
  by the physical distance between junctions, L_{physical}.
step 5: Assign each junction (v ∈ J) to its nearest clusters based on the
total Euclid distance defined as
          L_{v,c}_{ᵢ}= (L_{(v,c}_{ᵢ}₎^{leakage} + L_{(v,c}_{ᵢ}₎^{physical})/2.
      v ∈ clusterᵢ, if L_{v,c}_{ᵢ} ≤ L_{v,c}_{ᵢ}, ∀l ∈ {1,2,3, ... , k)
  where J is the set of all junctions, L_{v,ci} is the represent distance between
        junction i and centroid cᵢ, cᵢ is the centroid of cluster i,
step 6: Centroids redistribution
  step 6.1: For clusterᵢ, set junction vₖ as the new centroid. Replace the
  original centroid cᵢ and determine the new group of centroids (vₖ, c₂,
  c₃, ... , cₖ)
  step 6.2: Recalculate the leakage characteristics matrix in step 3.1 with
  the new group of centroids.
  step 6.3: Recalculate the distance from to vₖ all other junctions in
  clusterᵢ.
  step 6.4: For every junction in clusterᵢ, repeat step 6.1 to 6.3 to find the
  junction with the minimum total distance as the new centroid for
  clusterᵢ, i.e.,
        cᵢ^{new} = vₖ, if Σₘ₌₁^{M} Lᵥ_{ₖ}_{,v}_{ₘ}is minimum.
  where cᵢ^{new} is the new centroid for cluster i, M is all junctions in cluster
  i.
  step 6.5: Repeat step 6.1 to 6.4 for all clusters. Until the centroid
  distribution is stabilized.
step 7: Determine the sum of the distance of all clusters to their
  corresponding centroid from step 6. Repeat from step 3 to step 7 until
  the following relationship is satisfied.
      abs(sum(L_{v,c}_{^{new}}) − sum(lL_{v,c})) < tolerence
        or (iteration > number of iteration)
where l_{v,c} is the distance of each junction to its corresponding centroid, c
is the old set of centroids, c^{new} is the new set of centroids.
```

It is noted that in Step 3.1, the leakage characteristics matrix can be obtained by using different definitions, i.e., conventional leakage characteristic matrix based on pressure change or feature extraction with ML algorithms Although PCA and AE models are used in the clustering algorithm, other ML models can also be integrated into this framework, such as the Mahalanobis classification system (MCS). In Step 3.2, the physical distance between pairs of junctions is obtained by using Dijkstra's shortest pathfinding algorithm. Other shortest path algorithms could also be considered when dealing with different types of graphs, such as Floyd-Warshall algorithm. This step guarantees the clustered junctions are concentrated based on their network path distance. Both of the pair distance matrices are normalized by dividing their largest value. Therefore, the range of these distances is from 0 to 1. In Step 5, the represent distance between junctions is defined as the unweighted average of physical distance and leakage characteristics distance. The algorithm allows to assign different weights of the leakage characteristics distance and the physical distance. In Step 6, the process of centroid redistribution of each cluster requires re-acquiring the leakage characteristics matrix with the new set of centroids. Also, in Step 6, unlike the standard k-means which used the mean value of each cluster as its centroids, the optimal junctions (that minimize distance within the cluster) is set as the new centroids so that centroids remain on the junctions in the WDN.

With clusters of nodes determined, the recommended sensor placements are at the centroid of each cluster to maximize the value of sensor data acquisition. The clustering of nodes based on their hydraulic similarities and network distance also facilitates leak localization.

### Sensor Data Visualization

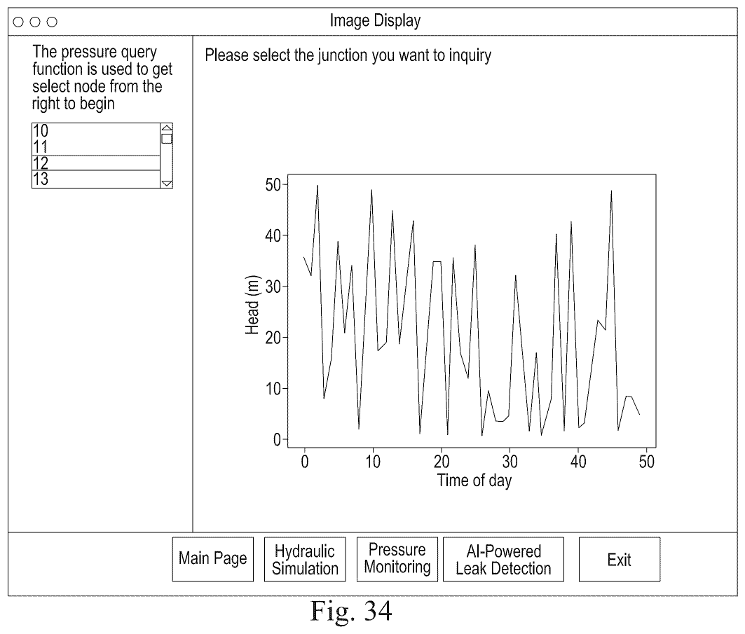

FIG. 34 illustrates an example interface to manage and display of data by water pressure monitoring sensor. An interface has been created to manage the data generated by the monitoring sensor. The data flow stream will be compatible to the data protocol of the existing SCADA system of the WSN. This allows to store, retrieve, and display sensor data according to the user demand Automatic data quality check is implemented, which gives warning on erroneous data such as abnormal value of the data. An example display of data collected by pressure monitoring sensors is shown in FIG. 34.

### AI Model for Intelligent Sensor Placement and Leak Detection

### Autoencoder for Leak Detection

AI applications requires sufficient amount of labeled data. This presents a major barrier for leak detection due to relative rare amount of labeled data corresponding to leak conditions. To overcome this technical barriers, the systems and methods are configured to implement an unsupervised ML model with Autoencoder (AE) neural network. The AE neural network model is based on a special type of neural network that is trained to reconstruct its input, so the output (y₁, y₂, y₃, . . . , yₙ) would contain the same information as its input (x₁, x₂, x₃, . . . , xₙ). To reduce the reconstruction error, the network is required to learn the hidden patterns between the input data.

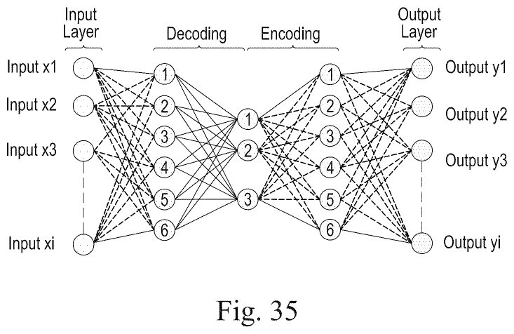

FIG. 35 is a schematic diagram showing the architecture of an autoencoder (AE) neural network. In FIG. 35, the numbers of neurons in the decoding layers and encoding layers are conceptual). The training process of the AE network involves firstly compresses the input vector x into a small dimension, which is called the encoding process. Then the model will reconstruct the compressed data into its original space, which is called the decoding process. By reducing the error between output and input, the weights and bias of the neurons in the neural network are adjusted to learn the relationship among the input data.

An innovative strategy is proposed in this study to detect the leaking situation by autoencoder neural network based on its reconstruction error. The reconstruction error is characterized by the mean square error:

$$MSE = \frac{1}{n} {\sum }_{i = 1}^{n} {( {x}_{i} - {y}_{i} )}^{2} \qquad ( 6 )$$

where MSE is the mean square error or reconstruction error, n is the dimension of the input vector x, xᵢ is the sample data and yᵢ is the predicted sample data.

For a model trained by dataset using normal (non-leak) condition, a large reconstruction error occurs it is inputted with data under leaking condition because the relationship described by the trained AE neural network is not valid under such condition. By setting a threshold in the construction error, the AE model can classify if a set of data corresponds to a leaking situation or a non-leaking situation.

### Random Forest for Leak Localization

The leakage localization can be defined as a classification problem, i.e., the leakage conditions are classified into different WDN partition zones (or clusters). There are various types of ML models for classification problems, such as the Artificial Neural Network, Support Vector Machine, Decision Tree, Random Forest (RF), etc. The systems and methods herein can employ Random Forest (RF) model because 1) RF is an efficient classification algorithm, and 2) it only needs a very few hyperparameters to be tuned. These help with the efficiency and consistency during the evaluation process.

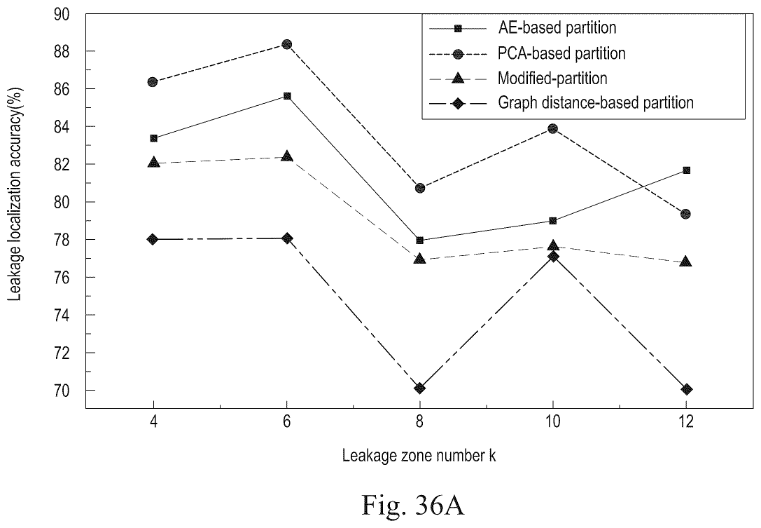

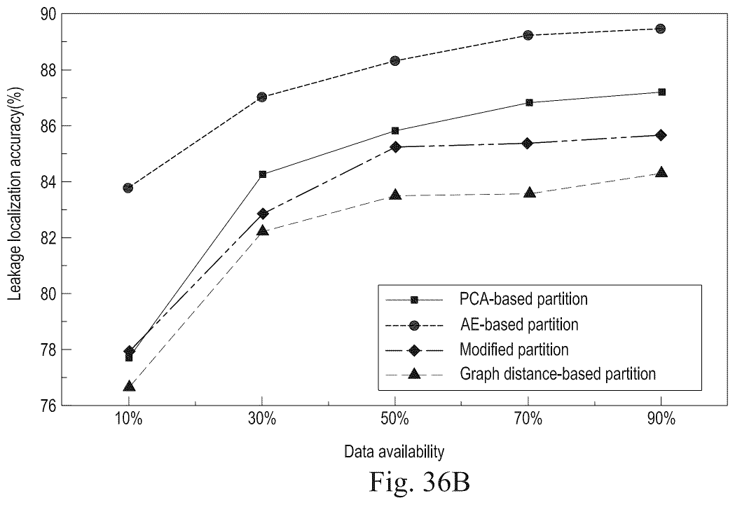

FIG. 36 illustrates graphs showing leakage localization accuracy with an RF model under a) different numbers of partition zones, and b) percentage of junctions with leakage data available under 10 partitions. The performance of leak localization was validated considering the impact of number of sensors. The effects of the number of sensors on the leakage zone localization accuracy are summarized in FIG. 36A. 20 trials are conducted for each case to eliminate the randomness and the average accuracy is plotted. The accuracy in leakage localization by RF consistently achieved top 2 performance by using AE-based or PCA-based partitions. It is noted that the accuracy of leak localization is worst when only considers the physical distance of junctions with no consideration of the leakage characteristics, which is the case with conventional ML model. It is noted that leakage zone localization using AE-based partition started to overperform that using the PCA-based partition for a larger number of partitions (i.e., 12). This might be attributed to that AE-based partition is more capable of identifying complex relationships from the data.

As with ML models, the more data used for model training, the better the ML performance. For the case of leak detection, the higher the percentage of nodes with historical failures, the more accurate the detection results. FIG. 36B shows the influence of different percentages of junctions with leakage data on the accuracy of leakage zone localization, which is performed by partitioning the WDN into 10 leakage zones via different partition methods. The results show that with leaking data available at more junctions, the leakage localization accuracy improves. The results also showed that the best performance in leak localization is achieved with RF-based leakage zone localization over PCA-based partition.

### Sensitivity Analysis of the Leak Detection Algorithm

Sensitivity study is conducted to evaluate the effects of leak size on the performance of the AI-based leak detection algorithm. The leaking size is an important factor that influences the detection system performance. Conceptually, detection of small leak is much difficult than large leak, since smaller leak has less influence on the status of WSN and can be inundated with noises such as the water demand fluctuations. For the sensitivity study, the leaking size is varied from 0.01 m to 0.12 m.

Small leaks tend to be classified under normal non-leaking situations (i.e., 0% correct detection). While normal non-leaking cases are all classified correctly (i.e., 100% correct detection). This gives an accuracy of around 50% for a balanced dataset with equal number of data under both leaking and non-leaking conditions. With increasing leaking sizes, the AE model achieved higher leak detection accuracy. This is reasonable since the larger the leak size, the more disturbance it will have on the pressure distribution in the WSN to allow its detection.

Additionally, the influence the compression ratio of the AE algorithm can be examined. The compression ratio is the number of uncompressed data divided by compressed data when constructing the AE neural network. It is an important hyperparameter of the AE neural network. A large compression ratio can not only save the physical data storage space but also force the AE model to learn the internal pattern of input data. However, too much compression may lead to excess information loss and decrease the detection accuracy.

The compression ratio is found to have a negative influence on the overall detection accuracy. As shown in FIG. 8, at the leaking size of 0.06 m, the accuracy decreased from 85.24% to 67.02% when compression ratio increases from 1 to 6. For leaking size of 0.11 m, the accuracy decreases from 100% to 80.75% when compression ratio increases from 1 to 6. This is reasonable since the higher compression ratio will loss more information of original dataset. However, it is also noticed that the influence of compression ratio is small for compression ratio less than 2. A compression ratio of around 1.5 appeared to achieve the best results. It also should be noted that compared to the leaking size, compression ratio has a relatively smaller impact on the detection accuracy.

### TECHNOMICS ANALYSES

Water leaks have led to significant direct and indirect costs. According to the Cleveland Water Department, the average cost for treated water is $487.53 per million gallons. In the year 2021 alone, the total annual water production reached 73,559 million gallons. Considering the aging water system have an average leaking rate around 30%, the direct cost attributed to water leaks amounted to a staggering $10,758,665 in 2021. Additionally, the entire United States experiences an average daily water leak of 6 billion gallons. As a result, the total direct cost is approximately $2,925,180 each day.

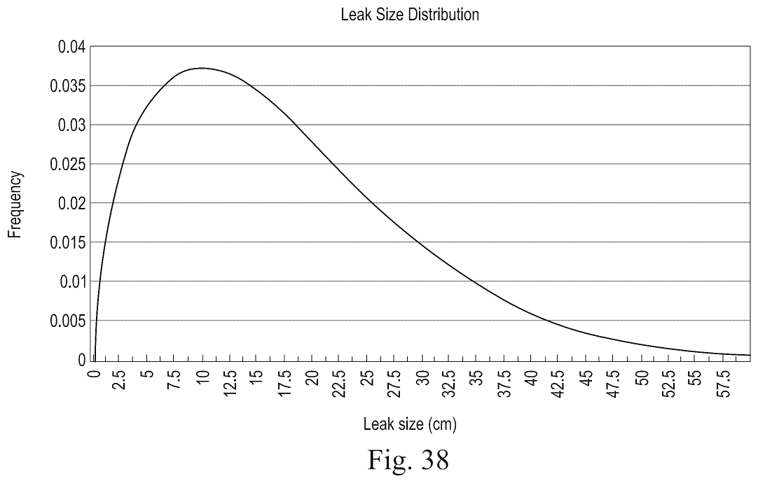

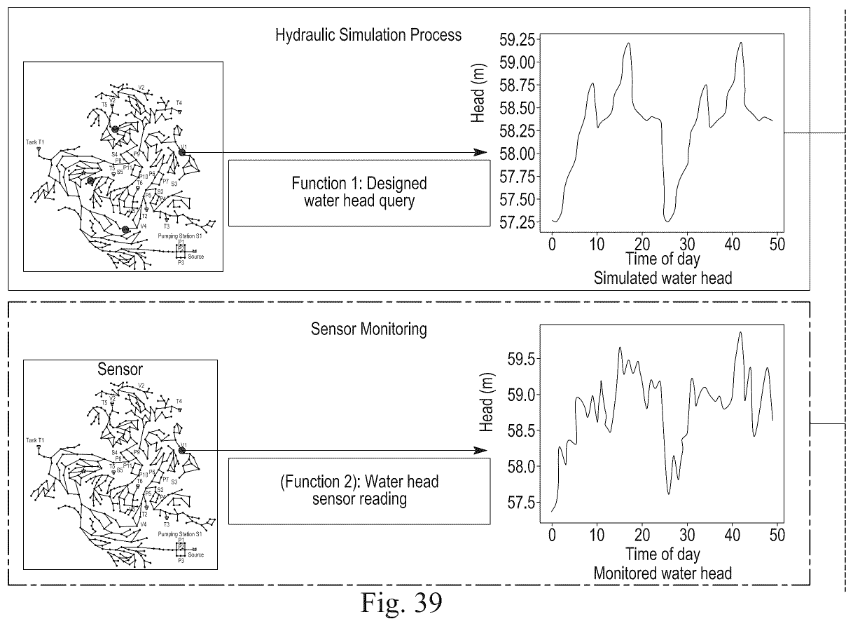

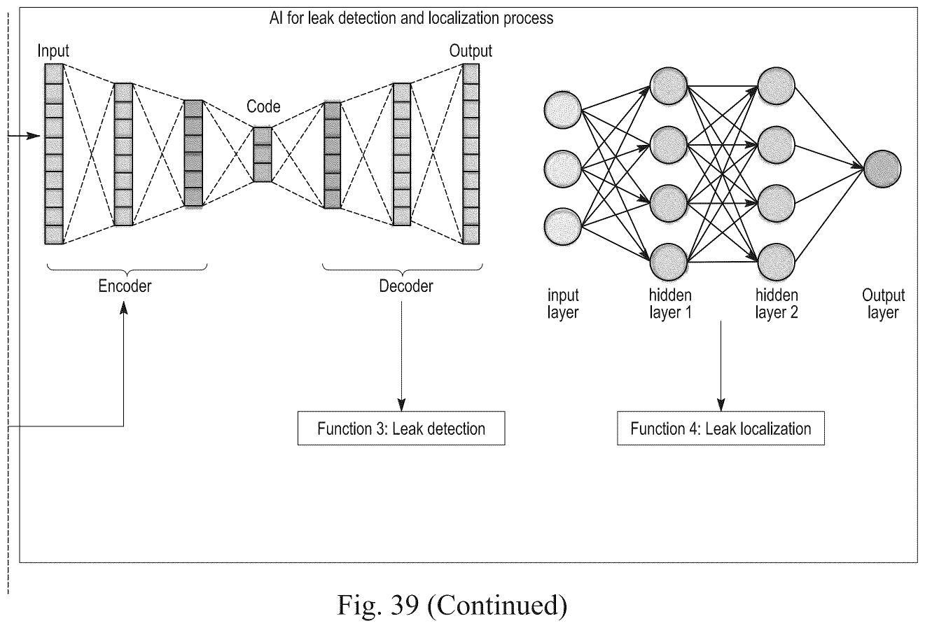

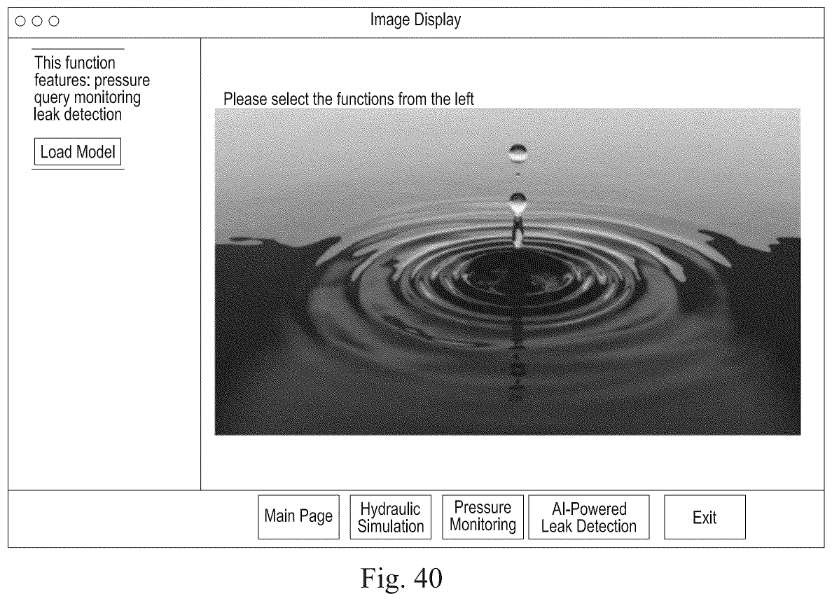

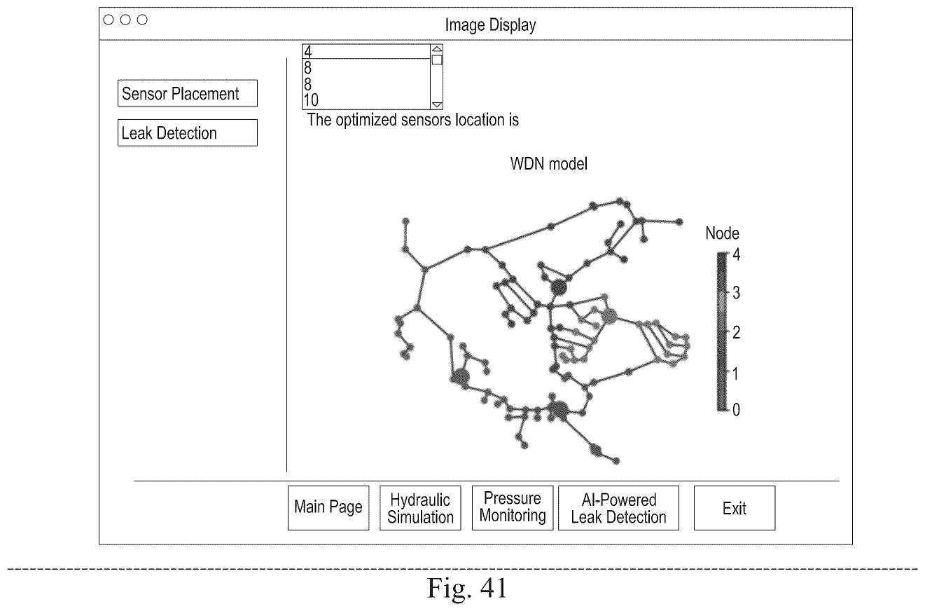

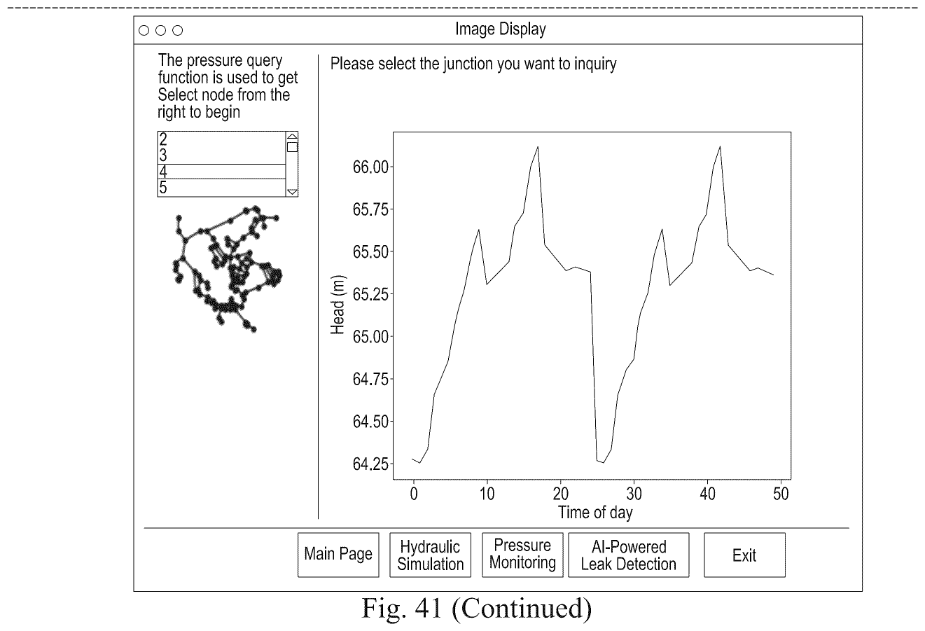

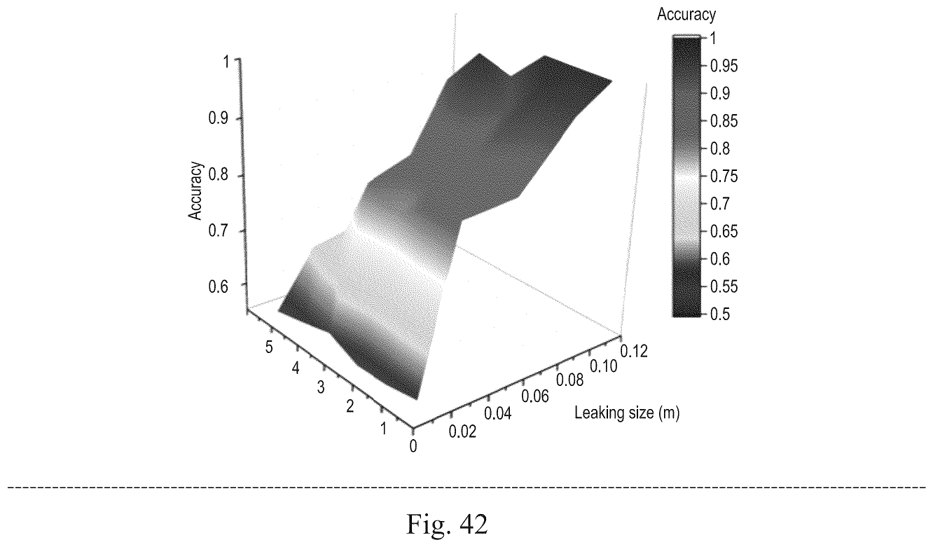

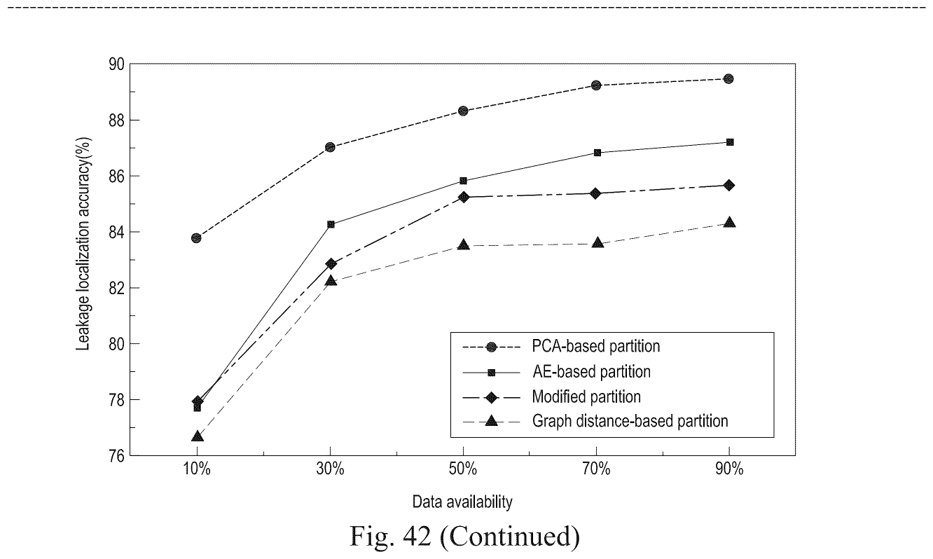

In order to estimate the economic savings of the proposed algorithm, it is assumed the leak size distribution follows a Weibull distribution as shown in Eq. 7, with the shape parameter (a) set to 1.5 and the scale parameter (b) to 20. FIG. 38 displays the plot of the leak size distribution.

$$f ( x , a , b ) = \frac{a}{b} {( \frac{x}{b} )}^{a - 1} {e}^{- {( \frac{x}{b} )}^{z}} \qquad ( 7 )$$

where a is the shape parameter, and b is the scale parameter.

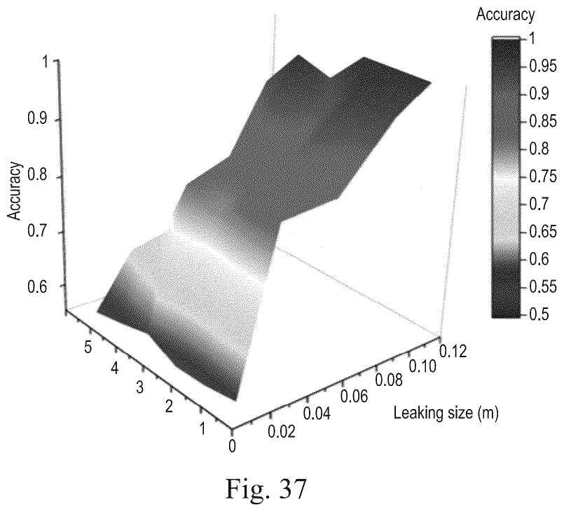

Upon applying the accuracy of developed leak detection algorithm to different sized leaks (FIG. 37), the probability of water leak prevention can be estimated. Given the assumption of the leak size distribution (FIG. 38) and the leak detection accuracy (FIG. 37), the proposed method can prevent 68.4% water leak if the detected leaks can be timely fixed. For water system with water supply such as the Cleveland water system, the potential economic savings is estimated to be $7,358,926.86 per year.

Besides the financial benefits to recoup the lost revenue, prevention of water leaks also help mitigate the health risks to the public and improve public perception. Contamination from external sources can enter the water system in the event of leaks and pipe failures, particularly when the pipe's internal pressure is lower than the pressure by the groundwater. Efficient leak detection can significantly reduce the chance of backflow, thereby minimizing the risks to public health.

The systems and methods described herein provide a solution to the intelligent water supply challenge by developing an innovative application framework based on AI-empowered leak detection and localization. The framework starts with a new clustering algorithm that guide the optimal sensor placement. This allows to use a small number of sensors to completely cover the conditions of the whole WSN, therefore, maximizing the values of the sensor data.

The use of the AI algorithm for accurate leak detection provides an improvement over existing approaches. The novel ML model allows leaks to be detected without a vast amount of labeled dataset under leak scenarios that is difficult to obtain. The unsupervised AE algorithm, as described herein, learns the patterns of non-leaking scenarios, making it a highly efficient and reliable approach adapted to the unique demand in leak detection. Besides, the ML leak detection method relies on changes in the water pressure patterns among multiple sensors (rather than pressure differences from a single sensor as with many existing ML model). Therefore, it achieves more robust and reliable results.

Besides, the novel system partition algorithm facilitates a semi-supervised ML approach for leak localization. The significant of this approach is that it only requires data at a portion of nodes with leak history to achieve accurate localization to cover the leaks across the whole WSN. Moreover, obtaining this historical data can be achieved by creating man-made leak scenarios such as through controlled hydrant openings, making it an effective solution under practical constraints with WSN operation.

The systems and methods described herein can implement user-friendly interface, excellent extensibility and generality that allows it to be integrated with the data from the existing water SCADA system, hydraulic simulation and data query, as well as the key component of AI-based real-time leak detection and localization. These present a cutting-edge solution to support intelligent water system monitoring and asset management.

The implications of the AI-empowered water leak detection system are vast, as it will empower public utilities to promptly identify leaks or other factors leading to pipe failures in the real-time. By supporting effective and timely maintenance measures, this system will recoup the economic values associated with the vast amount of non-revenue water and significantly reduces the risk of leak-related health issues.

In view of the foregoing structural and functional description, those skilled in the art will appreciate that portions of the invention may be embodied as a method, data processing system, or computer program product. Accordingly, these portions of the present invention may take the form of an entirely hardware embodiment, an entirely software embodiment, or an embodiment combining software and hardware. Furthermore, portions of the invention may be a computer program product on a computer-usable storage medium having computer readable program code on the medium. Any suitable computer-readable medium may be utilized including, but not limited to, static and dynamic storage devices, hard disks, optical storage devices, and magnetic storage devices.

Certain embodiments of the invention have also been described herein with reference to block illustrations of methods, systems, and computer program products. It will be understood that blocks of the illustrations, and combinations of blocks in the illustrations, can be implemented by computer-executable instructions. These computer-executable instructions may be provided to one or more processor of a general purpose computer, special purpose computer, or other programmable data processing apparatus (or a combination of devices and circuits) to produce a machine, such that the instructions, which execute via the processor, implement the functions specified in the block or blocks.

These computer-executable instructions may also be stored in computer-readable memory that can direct a computer or other programmable data processing apparatus to function in a particular manner, such that the instructions stored in the computer-readable memory result in an article of manufacture including instructions which implement the function specified in the flowchart block or blocks. The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions specified in the flowchart block or blocks.

It should further be understood that various aspects disclosed herein may be combined in different combinations than the combinations specifically presented in the description and accompanying drawings. It should also be understood that, depending on the example, certain acts or events of any of the processes or methods described herein may be performed in a different sequence, may be added, merged, or left out altogether (e.g., all described acts or events may not be necessary to carry out the techniques). In addition, while certain aspects of this disclosure are described as being performed by a single module or application for purposes of clarity, it should be understood that the techniques of this disclosure may be performed by a combination of units or modules associated with, for example, a local or distributed system.

What have been described above are examples. It is, of course, not possible to describe every conceivable combination of components or methods, but one of ordinary skill in the art will recognize that many further combinations and permutations are possible. Accordingly, the invention is intended to embrace all such alterations, modifications, and variations that fall within the scope of this application, including the appended claims. Where the disclosure or claims recite “a,” “an,” “a first,” or “another” element, or the equivalent thereof, it should be interpreted to include one or more than one such element, neither requiring nor excluding two or more such elements. As used herein, the term “includes” means includes but not limited to, the term “including” means including but not limited to. The term “based on” means based at least in part on.”

All references, publications, and patents cited in the present application are herein incorporated by reference in their entirety.

What is claimed is:

1. A system for leak detection and localization, comprising:
a water distribution network (WDN) partition stage programmed to cluster a WDN model into partition zones based on applying a modified k-means clustering algorithm to leakage characteristic data and physical connectivity data; and
a leakage monitoring stage programmed to (i) detect the occurrence of leakage in the WDN and provide leak detection data based on applying a trained unsupervised leakage detection machine-learning model to the partition zones and sensor data, and/or (ii) provide localization data to identify a location of a leakage zone in the WDN based on providing the leak detection data to a localization machine-learning model.

2. The system of claim 1, wherein the sensor data includes water pressure data.

3. The system of claim 1, wherein the leakage characteristic data includes a leakage characteristic matrix.

4. The system of claim 3, wherein the leakage characteristic matrix is calculated the leakage characteristics matrix using principal component analysis (PCA) to provide a PCA-based leakage characteristics matrix based on a training dataset of non-leaking data and a leakage matrix of monitored pressure when leakage occurs at respective junctions in the WDN.

5. The system of claim 3, wherein the leakage characteristic matrix is calculated the leakage characteristics matrix using an autoencoder (AE) neural network to provide an AE-based leakage characteristics matrix based on a leakage matrix of monitored pressure when leakage occurs at respective junctions in the WDN.

6. The system of claim 1, wherein the leakage detection machine-learning model further comprises at least one of a principal component analysis (PCA) machine-learning model or an autoencoder machine learning model, in which the PCA and/or autoencoder machine learning models are trained based on non-leaking data.

7. A computer-implemented method, comprising:
accessing, from non-transitory computer-readable memory, a water distribution network (WDN) model, the WDN model representing structural, physical, topological, hydraulic characteristics of the WDN;
performing clustering on a leakage characteristics matrix and physical to partition the WDN into leakage zones, in which the leakage characteristics matrix describes the leakage behaviors of each of a plurality of junctions in the WDN;
determining centroids of partitioned clusters and leakage zones;
providing a leakage detection machine-learning model, in which the leakage detection machine-learning model is trained based on non-leaking data and configured to detect leakage that occurs in the WDN based on; and
providing a leakage localization machine-learning model, in which the leakage localization machine-learning model is trained based on labeled leakage data and configured to locate a leakage zone in the WDN.

8. The method of claim 7, further comprising calculating the leakage characteristics matrix using principal component analysis (PCA) to provide a PCA-based leakage characteristics matrix.

9. The method of claim 7, further comprising calculating the leakage characteristics matrix using an autoencoder neural network.

10. A system comprising:
a graph convolution neural network (GCN) model trained to encode a water distribution network (WDN) based on topology and performance of service nodes of the WDN, the GCN model configured to provide GCN output data representative of repair actions in the WDN; and
a deep reinforcement learning method programmed to train parameters of the GCN model based on a measure of resilience determined from the outputs of GCN model representative of reward values corresponding to respective repair actions.

11. The system of claim 10, wherein the deep reinforcement learning method is further programmed to select an optimal repair sequence for the WDN.
